(19) United States
(12) Patent Application Publication
(10) Pub. No.: US 2007/0041789 A1
(43) Pub. Date: Feb. 22, 2007

(54) Secondary containment monitoring system

(75) Inventors: Thomas K. Monroe, Lakewood, CA (US); Zane A. Miller, Phoenix, AZ (US)

Correspondence Address: WOOD, HERRON & EVANS, LLP, 2700 CAREW TOWER, 441 VINE STREET, CINCINNATI, OH, 45202, US

(73) Assignee: OPW Fuel Management Systems

(21) Appl. No.: 11/586,233

(22) Filed: Oct. 25, 2006

Related U.S. Application Data
(63) Continuation of application No. 10/848,760, filed on May 18, 2004.
(60) Provisional application No. 60/471,828, filed on May 19, 2003.
(60) Provisional application No. 60/541,616, filed on Feb. 3, 2004.

(51) Int. Cl. B65G 5/00

(52) U.S. Cl. 405/54

(57) ABSTRACT

A leak detection and prevention system adapted to continuously monitor the spaces of a double wall hydrocarbon fuel handling system comprising storage tanks, product lines, vapor recovery lines, tank vent lines, etc. The system establishes and monitors a resident gas-pressure within the interstitial space to monitor the integrity of the primary and secondary containment. Change in resident gas-pressure in excess of a calibrated vacuum flow rate or the presence of liquid in any monitored space initiates an alarm. Once an alarm is signaled, the product delivery system is shut down and an audio-visual alarm is activated in close proximity to operating personnel. An onsite service call by qualified personnel is required to return the product handling system back into service. A qualified service technician connects to a communication port on the system control module to evaluate the cause of the failure. The system utilizes vacuum pressure to monitor for containment breaches. Furthermore, the system utilizes a Bernoulli-based device to produce the monitoring vacuum.

### CROSS-REFERENCE TO RELATED APPLICATION

The present application is related to prior provisional application Ser. No. 60/471,828, filed 05/19/03, entitled “SECONDARY CONTAINMENT MONITORING SYSTEM”, and to prior provisional application Ser. No. 60/541,616, filed 02/03/04, entitled “SECONDARY CONTAINMENT MONITORING SYSTEM”, from which priority is claimed, the contents of both of which are incorporated herein by this reference and are not admitted to be prior art with respect to the present invention by the mention in this cross-reference section.

### BACKGROUND

This invention relates to providing a system for improved site monitoring and control systems including vacuum-based storage tank monitoring. More specifically, this invention relates to providing a system for improved apparatus and methods for detecting and preventing leakage of materials from underground storage tanks (UST's) and associated piping. The environmental challenges facing industrial companies and governments throughout the world are numerous and complex. Designers within all levels of building and industry now seek to design and develop high-performance, environmentally safe and sustainable sites and facilities. National governments, nongovernmental organizations, and industry are making great advances in meeting the environmental challenges, although a great number technological difficulties remain.

A need exists for new systems that permit efficient management, monitoring and control of sites and the facilities located within the sites. Further, a need exists for a site management, monitoring and control system that is both highly responsive and readily adaptable to a wide range of applications.

Included within the scope of site management, monitoring and control is the protection against unauthorized and/or unintentional releases of hazardous materials into the environment. Legislative bodies continue to strengthen and reorganize laws relating to the storage and handling of hazardous materials.

The abundance of liquid petroleum-based materials within the world's industrial countries has directed specific focus on legislative programs designed to promote safe storage and handling of petroleum-based materials. The release of petroleum-based materials from underground storage tanks (UST's), and their connected piping, has resulted in tremendous safety hazards, health problems, economic loss, and damage to the environment. Many regulatory bodies now require stringent monitoring of UST systems. For example, within the United States, the State of California has led in legislating strict requirements for continuous leak monitoring of UST storage and material delivery systems.

In light of the above, it clear that a need exists for improved systems for handling a diverse range of environmental issues relating to management, monitoring and control of a facility or site.

### OBJECTS OF THE INVENTION

A primary object and feature of the present invention is to fill these needs and provide an improved secondary containment system relating to environmentally-hazardous products.

It is a further object and feature of the present invention to provide a hazardous product leak detection and prevention system utilizing continuous monitoring, which incorporates interstitial vacuum gas pressure into the leak detection process.

It is a further object and feature of the present invention to provide such a system capable of continuously monitoring the integrity of an installed and operational primary and secondary containment boundaries and spaces of environmentally-hazardous product containers.

It is a further object and feature of the present invention to provide such a system capable of continuously monitoring the integrity of double contained piping, flanges, fittings, etc., connected to an operational underground storage tank.

It is another object and feature of the present invention to provide such a system capable of recording ‘events’ (for example, changes in vacuum pressure and possible leaks) within a prescribed time frame, utilizing a programmed logic device.

It is a further object and feature of the present invention to provide such a system capable of counting reset vacuums within a prescribed time frame, utilizing a programmed logic device.

It is a further object and feature of the present invention to provide such a system capable of approximating event locations within an underground storage tank or its connected piping, utilizing a continuous vacuum monitor system.

It is a further object and feature of the present invention to provide such a system adaptable to shut off the product delivery pump when a pressure change or leak is detected in an underground storage tank or its connected piping, valves, flanges, etc.

It is a further object and feature of the present invention to provide such a system permitting convenient system diagnostics by a trained system technician.

It is a further object and feature of the present invention to provide such a system capable of interstitial integrity testing, which provides a trained system technician insight as to pressure parameters of the system.

It is a further object and feature of the present invention to provide such a system compliant with the United States Environmental Protection Agency's UST monitoring requirements.

It is a further object and feature of the present invention to provide such a system equivalent with the European Committee for Standardization (CEN) leak detection system requirements.

It is a further object and feature of the present invention to provide such a system compliant with current, State of California, continuous monitoring system requirements.

It is yet another object and feature of the present invention to provide such a system that is capable of removing leaking liquid from a secondary containment space.

It is a further object and feature of the present invention to provide such a system capable of communicating with a remote monitoring site.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a unified secondary containment system, relating to environmentally-hazardous petroleum products, comprising, in combination: tank means for containing such environmentally-hazardous petroleum products; piping means for transporting such environmentally-hazardous petroleum products; tank envelope means for essentially enveloping such tank means; tank interstitial space means, interstitial between such tank means and such tank envelope means, for secondary containment of such environmentally-hazardous petroleum products; piping envelope means for essentially enveloping such piping means; and piping interstitial space means, interstitial between such piping means and such piping envelope means, for secondary containment of such environmentally-hazardous petroleum products; wherein such tank interstitial space means and such piping interstitial space means in fluid communication together comprise combined interstitial space means for secondary containment of such environmentally-hazardous petroleum products; and gas-pressure setting means for setting at least one combined level of gas pressure in such combined interstitial space means substantially less than at least one tank level of gas pressure in such tank means and substantially less than at least one piping level of gas pressure in such piping means. Moreover, it provides such an unified secondary containment system further comprising monitoring means for essentially-continuous monitoring of such combined interstitial space means to detect deviations from such set at least one combined level of gas pressure.

In accordance with another preferred embodiment hereof, this invention provides a unified secondary containment system, relating to environmentally-hazardous petroleum products, comprising, in combination: at least one tank adapted to contain such environmentally-hazardous petroleum products; at least one piping adapted to transport such environmentally-hazardous petroleum products; at least one tank envelope structured and arranged to essentially envelope such at least one tank; at least one tank interstitial space, interstitial between such at least one tank and such at least one tank envelope, adapted to secondary containment of such environmentally-hazardous petroleum products; at least one piping envelope structured and arranged to essentially envelope such at least one piping; at least one piping interstitial space, interstitial between such at least one piping and such at least one piping envelope, adapted to secondary containment of such environmentally-hazardous petroleum products; wherein such at least one tank interstitial space and such at least one piping interstitial space in fluid communication together comprise at least one combined interstitial space adapted to secondary containment of such environmentally-hazardous petroleum products; and at least one gas-pressure setter structured and arranged to set at least one combined level of gas pressure in such at least one combined interstitial space substantially less than at least one tank level of gas pressure in such at least one tank and substantially less than at least one piping level of gas pressure in such at least one piping.

Additionally, it provides such a unified secondary containment system further comprising at least one monitor structured and arranged to essentially-continuously monitor such combined interstitial space to detect deviations from the at least one combined level of gas pressure. Also, it provides such a unified secondary containment system wherein such at least one monitor comprises at least one computer monitor structured and arranged to computer-assistedly monitor gas pressure in such at least one combined interstitial space. In addition, it provides such a unified secondary containment system further comprising at least one pump adapted to assist delivery of such environmentally-hazardous petroleum products. And, it provides such a unified secondary containment system wherein such at least one monitor comprises at least one alarm signal adapted to turn off such at least one pump. Further, it provides such a unified secondary containment system wherein such at least one gas pressure setter comprises at least one fluid flow system adapted to provide, essentially by Bernoulli effect, such at least one combined level of gas pressure. Even further, it provides such a unified secondary containment system wherein such at least one fluid flow system comprises such at least one pump. Moreover, it provides such a unified secondary containment system wherein such at least one monitor comprises: at least one first-components system structured and arranged to have at least one sensory coupling with such combined interstitial space and comprising such at least one gas pressure setter; and at least one second-components system structured and arranged to have at least one signal coupling and at least one control coupling with such at least one first-components system; wherein such at least one first-components system comprises a set of sump-access-locatable elements; and wherein such at least one second-components system comprises a set of operator-access-locatable elements.

In accordance with another preferred embodiment hereof, this invention provides a secondary containment system, relating to environmentally-hazardous petroleum products, comprising, in combination: tank means for containing such environmentally-hazardous petroleum products; tank envelope means for essentially enveloping such tank means; tank interstitial space means, interstitial between such tank means and such tank envelope means, for secondary containment of such environmentally-hazardous petroleum products; and gas-pressure setting means for setting at least one interstitial level of gas pressure in such tank interstitial space means substantially less than at least one tank level of gas pressure in such tank means; wherein such gas pressure setting means comprises fluid flow means for providing, essentially by Bernoulli effect, such at least one interstitial level of gas pressure. Additionally, it provides such a secondary containment system wherein such fluid flow means comprises such pump means. Also, it provides such a secondary containment system further comprising monitoring means for essentially-continuous monitoring of such tank interstitial space means to detect deviations from the at least one interstitial level of gas pressure.

In accordance with another preferred embodiment hereof, this invention provides a secondary containment system, relating to environmentally-hazardous petroleum products, comprising, in combination: at least one tank adapted to contain such environmentally-hazardous petroleum products; at least one tank envelope structured and arranged to essentially envelope such at least one tank; at least one tank interstitial space, interstitial between such at least one tank and such at least one tank envelope, adapted to secondary containment of such environmentally-hazardous petroleum products; and at least one gas-pressure setter structured and arranged to set at least one interstitial level of gas pressure in such at least one tank interstitial space substantially less than at least one tank level of gas pressure in such at least one tank; wherein such at least one gas pressure setter comprises at least one fluid flow system adapted to provide, essentially by Bernoulli effect, such at least one interstitial level of gas pressure. In addition, it provides such a secondary containment system wherein such at least one fluid flow system comprises such at least one pump.

And, it provides such a secondary containment system further comprising at least one monitor structured and arranged to essentially-continuously monitor such tank interstitial space to detect deviations from the at least one interstitial level of gas pressure. Further, it provides such a secondary containment system wherein such at least one monitor comprises at least one computer monitor structured and arranged to computer-assistedly monitor gas pressure in such at least one tank interstitial space. Even further, it provides such a secondary containment system further comprising at least one pump adapted to assist delivery of such environmentally-hazardous petroleum products.

Moreover, it provides such a unified secondary containment system wherein such at least one monitor comprises at least one alarm signal adapted to turn off such at least one pump. Additionally, it provides such a secondary containment system wherein such at least one monitor comprises: at least one first-components system structured and arranged to have at least one sensory coupling with such combined interstitial space and comprising such at least one gas pressure setter; and at least one second-components system structured and arranged to have at least one signal coupling with such at least one first-components system; wherein such at least one first-components system comprises a set of sump-access-locatable elements; and wherein such at least one second-components system comprises a set of operator-access-locatable elements.

In accordance with another preferred embodiment hereof, this invention provides a control system, relating to interstitial monitoring of secondary containment of environmentally-hazardous products handlable in at least one primary container having at least one envelope essentially enveloping such at least one primary container and having at least one interstitial space between such at least one primary container and such at least one envelope and having at least one gas pressure setter adapted to set at least one interstitial level of gas pressure in such at least one interstitial space substantially less than at least one primary-container level of gas pressure in such at least one primary container, such control system comprising, in combination: control-components means for providing at least two kinds of control-components to assist monitoring of the at least one interstitial space; wherein at least one kind of such at least two kinds of control-components comprises gas-pressure-control components means for assisting control of gas pressure in the at least one interstitial space; control-components box means for mounting and enclosing such control-components means; and geometrical-positioning means for locating such control-components box means adjacent and external to the at least one primary container. Also, it provides such a control system further comprising: electrical-components means for providing electrical components remotely coupleable with at least one such control-component; and electrical-components box means for mounting and enclosing such electrical-components means.

In accordance with another preferred embodiment hereof, this invention provides a control system, relating to interstitial monitoring of secondary containment of environmentally-hazardous products handlable in at least one primary container having at least one envelope essentially enveloping such at least one primary container and having at least one interstitial space between such at least one primary container and such at least one envelope and having at least one gas pressure setter adapted to set at least one interstitial level of gas pressure in such at least one interstitial space substantially less than at least one primary-container level of gas pressure in such at least one primary container, such control system comprising, in combination: at least one control-components system adapted to provide at least two kinds of control-components to assist monitoring of the at least one interstitial space; wherein at least one kind of such at least two kinds of control-components comprises at least one gas-pressure-control component adapted to assist control of gas pressure in the at least one interstitial space; at least one control-components box adapted to mount and enclose such at least one control-components system; and at least one geometrical positioner adapted to locate such at least one control-components box adjacent and external to the at least one primary container in addition, it provides such a control system further comprising: at least one electrical-components system adapted to provide at least one electrical component remotely coupleable with at least one such control-component; and at least one electrical-components box adapted to mount and enclose such at least one electrical-components system. And, it provides such a control system wherein such at least one electrical-components box comprises at least one tamper-proof system to limit unauthorized access to such at least one electrical-components system. Further, it provides such a control system wherein such at least one electrical-components box comprises: at least one lock adapted to limit unauthorized access to such at least one electrical-components system; wherein such at least one electrical-components box may be safely placed in at least one easily accessible location while limiting unauthorized access to such at least one electrical-components system.

Even further, it provides such a control system further comprising at least one electrical coupling adapted to electrically couple such at least one control-components system with such at least one electrical-components system. Moreover, it provides such a control system further comprising at least one modem, located in such at least one electrical-components box, for assisting remote management of the secondary containment. Additionally, it provides such a control system wherein such at least one electrical-components box comprises at least one external-surface element adapted to permit, without providing internal access to such at least one electrical-components system, at least one safety signal to be read and at least one alarm to be disabled. Also, it provides such a control system wherein such at least one electrical-coupling system comprises at least one junction-box adapted to provide junction box assistance with such electrical coupling. In addition, it provides such a control system wherein such at least one electrical-coupling system comprises at least one wireless communicator adapted to wirelessly assist such electrical coupling.

And, it provides such a control system wherein such at least one gas-pressure-control component comprises at least one differential pressure switch adapted to signal operation within at least one preferred range of interstitial-space gas pressure. Further, it provides such a control system wherein such at least one gas-pressure-control component comprises at least one valve adapted to control gas pressure entry to such at least one interstitial space. Even further, it provides such a control system wherein such at least one differential pressure switch is electrically coupled with at least one such electrical component. Moreover, it provides such a control system wherein at least one such electrical component of such at least one electrical-components box is adapted to control such at least one valve.

Additionally, it provides such a control system wherein such at least one gas-pressure-control component comprises at least one tank-safety pressure limiter connected with such at least one interstitial space. Also, it provides such a control system wherein such at least one gas-pressure-control component comprises at least one gas pressure flow rate restrictor adapted to restrict the rate of gas pressure flow between at least one source of unregulated gas pressure and such at least one interstitial space. In addition, it provides such a control system wherein: such at least one control-components system comprises at least one control component adapted to send at least one signal in the presence of liquid; wherein such at least one signal is adapted to be sent to at least one such electrical component of such at least one electrical-components box; and such at least one electrical-components box is adapted to generate at least one alarm upon receiving such at least one signal. And, it provides such a control system wherein such at least one control component adapted to send at least one signal in the presence of liquid comprises at least one liquid holding vessel comprising at least one float switch.

Further, it provides such a control system wherein such at least one electrical-components system comprises at least one microprocessor structured and arranged to: be user-programmable to set alarm conditions and to set control operations of such at least one control-components system; receive signal information from at least such at least one control-components system; and send at least one control signal adapted to control at least one pump adapted to pump such environmentally-hazardous products, at least one gas pressure valve, and at least one alarm condition. Even further, it provides such a control system wherein such at least one electrical-components system comprises at least one power supply adapted to provide a voltage useable by such at least one microprocessor. Moreover, it provides such a control system wherein such at least one electrical-components system comprises at least one set of relays adapted to assist control of such at least one pump and such at least one gas pressure valve. Additionally, it provides such a control system wherein such at least one control-components box contains at least one heater to adjustably heat such at least one control-components system. Also, it provides such a control system wherein such at least one electrical-components box contains at least one data port adapted to provide microprocessor connectibility for diagnostic purposes. In addition, it provides such a control system wherein such at least one control-components box further contains at least one atmospheric gas pressure line connectible between such at least one differential pressure switch and atmospheric gas pressure.

In accordance with another preferred embodiment hereof, this invention provides a secondary containment system relating to environmentally-hazardous petroleum products, comprising, in combination: handling container means for containment during handling of such environmentally-hazardous petroleum products; handling container envelope means for essentially enveloping such handling container means; handling container interstitial space means, interstitial between such handling container means and such handling container envelope means, for secondary containment of such environmentally-hazardous petroleum products; gas-pressure setting means for setting at least one interstitial level of gas pressure in such handling container interstitial space means substantially less than at least one handling containment level of gas pressure in such handling container means; and monitoring means for essentially-continuous monitoring of such handling container interstitial space means to detect deviations from the at least one interstitial level of gas pressure. And, it provides such a secondary containment system wherein such gas pressure setting means comprises fluid flow means for providing, essentially by Bernoulli effect, such at least one interstitial level of gas pressure.

In accordance with another preferred embodiment hereof, this invention provides a secondary containment system relating to environmentally-hazardous petroleum products, comprising, in combination: at least one handling container adapted to contain while handling such environmentally-hazardous petroleum products; at least one handling container envelope structured and arranged to essentially envelope such at least one handling container; at least one handling container interstitial space, interstitial between such at least one handling container and such at least one handling container envelope, adapted to secondary containment of such environmentally-hazardous petroleum products; at least one gas-pressure setter structured and arranged to set at least one interstitial level of gas pressure in such at least one handling container interstitial space substantially less than at least one handling container level of gas pressure in such at least one handling container; and at least one monitor structured and arranged to essentially-continuously monitor such handling container interstitial space to detect deviations from the at least one interstitial level of gas pressure.

Further, it provides such a secondary containment system wherein such at least one gas pressure setter comprises at least one fluid flow system adapted to provide, essentially by Bernoulli effect, such at least one interstitial level of gas pressure. Even further, it provides such a secondary containment system further comprising: at least one interstitial riser means, including at least one sealed upper cap, adapted to provide access through such at least one handling container to such at least one handling container interstitial space; and at least one gas pressure line adapted to provide at least one such level of interstitial gas pressure; wherein such at least one sealed upper cap is adapted to provide access for such at least one gas pressure line to such at least one handling container interstitial space. Moreover, it provides such a secondary containment system wherein such at least one monitor comprises at least one computer monitor structured and arranged to computer-assistedly monitor gas pressure in such at least one handling container interstitial space. Additionally, it provides such a secondary containment system further comprising at least one pump adapted to assist delivery of such environmentally-hazardous petroleum products.

Also, it provides such a secondary containment system wherein such at least one monitor comprises at least one alarm signal adapted to turn off such at least one pump. In addition, it provides such a secondary containment system wherein such at least one fluid flow system comprises such at least one pump. And, it provides such a secondary containment system wherein such at least one pump comprises at least one siphon port; and such at least one siphon port comprises at least one source of gas pressure used by such at least one monitor. Further, it provides such a secondary containment system wherein such at least one monitor comprises: at least one control-components system adapted to provide at least two kinds of control-components to assist monitoring of the at least one interstitial space; wherein at least one kind of such at least two kinds of control-components comprises at least one gas-pressure-control component adapted to assist control of gas pressure in the at least one interstitial space; at least one control-components box adapted to mount and enclose such at least one control-components system; at least one geometrical positioner adapted to locate such at least one control-components box adjacent and external to the at least one primary container; at least one electrical-components system adapted to provide at least one electrical component remotely coupleable with at least one such control-component; and at least one electrical-components box adapted to mount and enclose such at least one electrical-components system. Even further, it provides such a secondary containment system wherein such at least one electrical-components box comprises at least one tamper-proof system to limit unauthorized access to such at least one electrical-components system.

Moreover, it provides such a secondary containment system wherein such at least one electrical-components box comprises: at least one lock adapted to limit unauthorized access to the at least one electrical-components system; wherein such at least one electrical-components box may be safely placed in at least one easily accessible location while limiting unauthorized access to the at least one electrical-components system. Additionally, it provides such a secondary containment system further comprising at least one electrical coupling adapted to electrically couple such at least one control-components system with such at least one electrical-components system. Also, it provides such a secondary containment system further comprising at least one modem, located in such at least one electrical-components box, for assisting remote management of the secondary containment. In addition, it provides such a secondary containment system wherein such at least one electrical-components box comprises at least one external-surface element adapted to permit, without providing internal access to such at least one electrical-components system, at least one safety signal to be read and at least one alarm to be disabled.

And, it provides such a secondary containment system wherein such at least one electrical-coupling system comprises at least one junction-box adapted to provide junction box assistance with such electrical coupling. Further, it provides such a secondary containment system wherein such at least one electrical-coupling system comprises at least one wireless communicator adapted to wirelessly assist such electrical coupling. Even further, it provides such a secondary containment system wherein such at least one gas-pressure-control component comprises at least one differential pressure switch adapted to signal operation within at least one preferred range of interstitial-space gas pressure. Moreover, it provides such a secondary containment system wherein such at least one gas-pressure-control component comprises at least one valve adapted to control gas pressure entry to such at least one interstitial space. Additionally, it provides such a secondary containment system wherein such at least one differential pressure switch is electrically coupled with at least one such electrical component. Also, it provides such a secondary containment system wherein at least one such electrical component of such at least one electrical-components box is adapted to control such at least one valve. In addition, it provides such a secondary containment system wherein such at least one gas-pressure-control component comprises at least one tank-safety pressure limiter connected between such at least one valve and such at least one interstitial space. And, it provides such a secondary containment system wherein such at least one gas-pressure-control component comprises at least one gas pressure flow rate restrictor adapted to restrict the rate of gas pressure flow between at least one source of unregulated gas pressure and such at least one interstitial space.

Further, it provides such a secondary containment system wherein: such at least one control-components system comprises at least one control component adapted to send at least one signal in the presence of liquid; wherein such at least one signal is adapted to be sent to at least one such electrical component of such at least one electrical-components box; and such at least one electrical-components box is adapted to generate at least one alarm upon receiving such at least one signal. Even further, it provides such a secondary containment system wherein such at least one control component adapted to send at least one signal in the presence of liquid comprises at least one liquid holding vessel comprising at least one float switch. Moreover, it provides such a secondary containment system wherein such at least one electrical-components system comprises at least one microprocessor structured and arranged to: be user-programmable to set alarm conditions and to set control operations of such at least one control-components system; receive signal information from at least such at least one control-components system; and send control signal adapted to control at least one pump adapted to pump such environmentally-hazardous products, at least one gas-pressure valve, and at least one alarm condition.

Still further, it provides such a secondary containment system wherein such at least one electrical-components system comprises at least one power supply adapted to provide a voltage useable by such at least one microprocessor. Also, it provides such a secondary containment system wherein such at least one electrical-components system comprises at least one set of relays adapted to assist control of such at least one pump and such at least one valve. In addition, it provides such a secondary containment system wherein such at least one control-components box contains at least one heater to adjustably heat such at least one control-components system. And, it provides such a secondary containment system wherein such at least one electrical-components box contains at least one data port adapted to provide microprocessor connectibility for diagnostic purposes.

Even further, it provides such a secondary containment system wherein such at least one control-components box further contains at least one atmospheric gas pressure line connectible between such at least one differential pressure switch and atmospheric gas pressure. Relating to vacuum monitoring of secondary containment systems relating to environmentally-hazardous petroleum products, a method of installation of at least one interstitial-space monitoring system comprising, in combination, the steps of: providing at least one first-components system structured and arranged to have at least one sensory coupling with such at least one interstitial space and comprising at least one gas pressure setter adapted to set at least one gas pressure in such at least one interstitial space and at least one second-components system structured and arranged to have at least one signal coupling with such at least one first-components system; wherein such at least one first-components system comprises a set of sump-access-locatable elements; and wherein such at least one second-components system comprises a set of operator-access-locatable elements; securely mounting such at least one first-components system to at least one sump structure; installing at least one vacuum line entry connection between such at least one first-components system and at least one vacuum source; and installing at least one vacuum line entry connection between such at least one first-components system and such at least one interstitial space.

Even further, it provides such a method further comprising the step of installing at least one vacuum line exit connection between such at least one first-components system and such at least one interstitial space. Even further, it provides such a method further comprising the steps of: installing at least one selectable isolator to permit selective monitoring of at least one interstitial space portion from at least one other interstitial space portion of such at least one interstitial space; and installing at least one vacuum branch line between such at least one vacuum line entry connection and such at least one other such at least one interstitial space. Even further, it provides such a method further comprising the step of installing at least one vacuum branch line between such at least one vacuum line exit connection and such at least one other such at least one interstitial space. Even further, it provides such a method further comprising the steps of: installing at least one system compatible product line fitting; connecting at least one vacuum line connection to such at least one system compatible product line fitting; and vacuum-purging at least one product line of residual product.

In accordance with another preferred embodiment hereof, this invention provides relating to vacuum monitoring of secondary containment systems relating to environmentally-hazardous petroleum products, a method of operation of at least one interstitial-space monitoring system comprising, in combination, the steps of: initializing at least one product delivery pump to set at least one interstitial vacuum pressure within at least one interstitial vacuum pressure range; essentially continuously monitoring whether such at least one interstitial vacuum pressure is within such at least one interstitial vacuum pressure range; on detection of such at least one interstitial vacuum pressure outside such at least one interstitial vacuum range, resetting such at least one interstitial vacuum pressure to within such at least one interstitial vacuum pressure range; and generating at least one alarm if such at least one interstitial vacuum pressure falls outside such at least one interstitial vacuum pressure range within at least one first preselected time span. Even further, it provides such a method further comprising the step of, upon such at least one alarm, disabling such at least one product delivery pump.

Even further, it provides such a method further comprising the step of generating at least one alarm if, on detection of such at least one interstitial vacuum pressure outside such at least one interstitial vacuum range, such resetting can not be accomplished within at least one second preselected time span. Even further, it provides such a method further comprising the steps of: diagnosing the cause of such at least one alarm by at least one trained technician; and reinitializing operation. Even further, it provides such a method wherein such at least one interstitial vacuum pressure range is from about one inch of water to about 120 inches of water. Even further, it provides such a method wherein such at least one interstitial vacuum pressure range is from about one inch of water to about 20 inches of water. Even further, it provides such a method wherein such at least one interstitial vacuum pressure range is from about fifteen inches of water to about 20 inches of water.

In accordance with another preferred embodiment hereof, this invention provides relating to vacuum monitoring of secondary containment systems relating to environmentally-hazardous petroleum products, a method of calibration of at least one interstitial-space monitoring system comprising, in combination, the steps of: initiating at least one system calibration routine within at least one computer monitor; and calibrating at least one pressure setting of at least one differential pressure switch using at least one other pressure gauging device. Even further, it provides such a method further comprising the step of calibrating at least one flow recharge rate through at least one flow restriction device using at least one other flow meter.

### BRIEF DESCRIPTION OF THE DRAWINGS

FIG. 1 is a diagram generally illustrating a continuous vacuum monitoring system according to a preferred embodiment of the present invention.

FIG. 2 is a diagram generally illustrating the product storage and delivery monitoring components of the continuous vacuum monitoring system according to the preferred embodiment of FIG. 1.

FIG. 3 is a diagram generally illustrating the system electrical sensing, control, data logging and alert components of the continuous vacuum monitoring system according to the preferred embodiment of FIG. 1.

FIG. 4 is a data module flow chart for installation and operation of the continuous vacuum monitoring system according to a preferred embodiment of the present invention.

FIG. 5 is a control panel software flow chart for testing and system diagnostics after a shutdown of the continuous vacuum monitoring system, according to a preferred embodiment of the present invention.

FIG. 6 is a diagram generally illustrating the operating principles and component arrangements of a continuous vacuum monitoring system according to another preferred embodiment of the present invention.

FIG. 7 is a plan view diagrammatically illustrating a typical site installation of the continuous vacuum monitoring system according to the preferred embodiment of FIG. 6.

FIG. 8 is a sectional view, through the section 8-8 of FIG. 7, diagrammatically illustrating a typical installation of a continuous vacuum monitoring sump unit within a typical product storage tank application.

FIG. 9 is a diagram further illustrating a typical installation of the continuous vacuum monitoring sump unit within a typical product storage tank.

FIG. 10 is an interior view of the continuous vacuum monitor sump unit illustrating a preferred arrangement of operating components according to the preferred embodiment of FIG. 8 and FIG. 9.

FIG. 11 is the detailed view 10 of FIG. 8, in partial sectional view, further illustrating a typical installation of the continuous vacuum monitor sump unit within a typical product storage tank.

FIG. 12 is a partial cross-sectional view, through an underground containment sump, illustrating the use of an alternate vacuum-generating device according to a preferred embodiment of the present invention.

FIG. 13 is cross-sectional view of a vacuum generator according to the preferred embodiment of FIG. 12.

FIG. 14 is a cross-sectional view through a vacuum-generating nozzle according to the preferred embodiment of FIG. 13.

FIG. 15a is a diagram illustrating the internal component arrangements of a continuous vacuum monitor remote unit according to the preferred embodiment of FIG. 6.

FIG. 15b is a diagram illustrating the internal component arrangements of another continuous vacuum monitor remote unit embodiment, according to the present invention.

FIG. 16 is a diagram illustrating the continuous vacuum monitor system, interoperating with a remote management system, according to a preferred embodiment of the present invention.

FIG. 17 is a front view illustrating a preferred arrangement, of a control panel display, according to the embodiment of FIG. 6.

FIG. 18 is a front view illustrating another preferred control panel display arrangement according to the preferred embodiment of FIG. 6.

FIG. 19 generally illustrates the installation steps for the continuous vacuum monitor sump unit, representative of a typical site installation, according to preferred methods of the present invention.

FIG. 20 generally illustrates representative preferred installation steps of a typical site installation of power and communication connections between the continuous vacuum monitor sump unit and the continuous vacuum monitor remote unit according to the present invention.

FIG. 21 generally illustrates preferred initialization steps for the continuous vacuum monitor system according to the present invention.

FIG. 22 generally illustrates preferred calibration steps for a system differential pressure switch, located within the continuous vacuum sump unit according to the present invention.

FIG. 23 generally illustrates preferred steps for field calibration of a system pressure flow control valve according to the present invention.

### DETAILED DESCRIPTION OF BEST MODES AND PREFERRED EMBODIMENTS OF THE INVENTION

The following specification discloses preferred embodiments of a leak detection and prevention system preferably adapted to continuously monitor the interstitial space of a double-wall environmentally hazardous material handling system. The system preferably establishes and monitors a resident gas-pressure within the interstitial space to monitor the integrity of the primary and secondary containment. Change in resident gas-pressure in excess of a calibrated vacuum flow rate or the presence of liquid in any monitored interstice preferably initiates an alarm. Preferably, once an alarm is signaled, the environmentally hazardous material delivery systems are shut down and an audio-visual alarm is activated in close proximity to operating personnel. Preferably, an onsite service call by qualified personnel is required to return the system back into service.

The term “tank” shall include within its definition all product storage arrangements capable of storing a quantity of product (at least embodying herein tank means for containing such environmentally-hazardous petroleum products). The term “piping” shall include in its definition all product containers capable of transporting a quantity of product liquid and/or vapor (at least herein embodying piping means for transporting such environmentally-hazardous petroleum products).

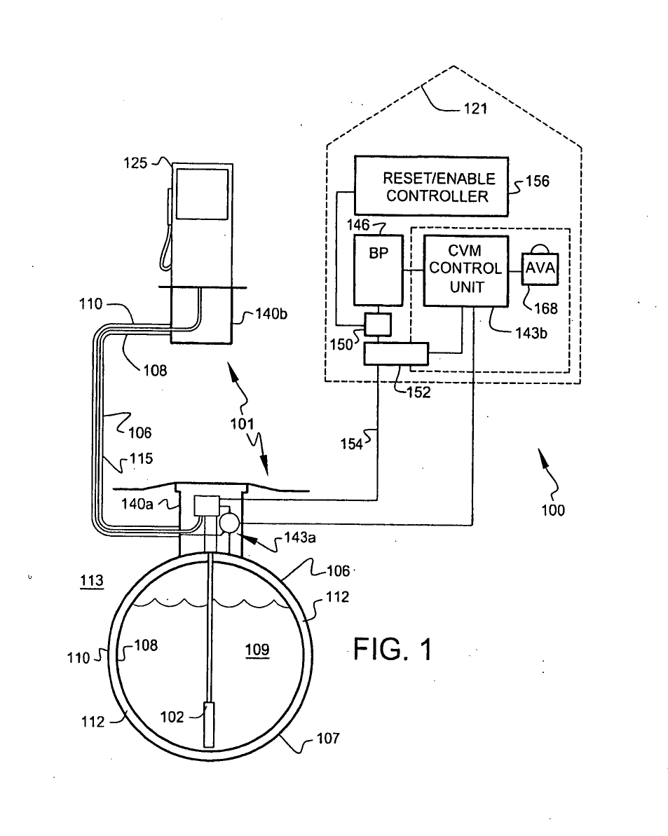

In reference to the drawings, FIG. 1 is a diagram generally illustrating a continuous vacuum monitoring system (hereinafter referred to as CVM system 100) according to a preferred embodiment of the present invention. Preferably, CVM system 100 continuously monitors the integrity of secondary containment space 112 of installed and operational multi-wall liquid product containers 106. Within the teachings of this specification, the term “product container” shall be understood to include above ground and underground storage tank (UST) systems including the piping connected to the underground storage tanks, valves, flanges, containment sumps and any other fluid handling device connected to the UST. Product container 106 preferably comprises at least one secondary containment space 112 located between primary containment boundary 108 and surrounding environment 113, as shown. In the event of a failure within primary containment boundary 108, leaking product 109 is preferably protectively collected and confined, preferably within at least one secondary containment space 112. In applications where stored product 109 is an environmentally hazardous material, such as petroleum fuel, it is necessary to monitor the condition of primary containment boundary 108, secondary containment boundary 110, and any additional boundaries and spaces.

The preferred design and operating principal of CVM system 100 is continuous vacuum monitoring. Preferably, CVM system 100 utilizes continuous gas pressure monitoring using a low resident gas pressure. CVM system 100 is preferably designed to continuously monitor the containment condition of primary containment boundary 108 and secondary containment boundary 110 by sensing changes in gas pressure (preferably a negative “vacuum” gas-pressure) applied to the interior of interstitial secondary containment space 112. Typically, a detected change in gas pressure indicates the possible presence of a containment breach. Typically, a detected change in vacuum gas pressure exceeding predetermined system thresholds indicates the presence of a containment breach. Preferably, a detected change in vacuum gas pressure exceeding predetermined system threshold initiates a system alarm and a protective shutdown of the product storage and delivery system 101.

In the present disclosure, product storage and delivery system 101 comprises components commonly found in typical product storage and delivery systems, including; underground storage tank 107, submerged turbine pump 102 (hereinafter referred to as STP 102), breaker panel 146, reset/enable controller 156, double contained piping 115, containment sump 140a, dispenser sump 140b and STP line voltage electrical conductor 154.

In the illustrated example of FIG. 1, CVM system 100 preferably monitors double wall underground storage tank 107 (hereinafter referred to as UST 107) and double wall (or double contained) piping 115, which preferably transfers product 109 (e.g. liquid fuel) between underground storage tank 107 and product delivery device 125 (in the present example, a fuel dispenser). It should be noted that double contained piping 115 typically comprises one or more product supply lines (as shown), vapor recovery lines and primary tank vent lines. Product storage and delivery monitoring components of CVM system 100 are preferably housed within continuous vacuum monitor sump unit 143a. Preferably, continuous vacuum monitor sump unit 143a comprises a protective housing, preferably a rectangular shaped box, adapted to hold the gas pressure management components of CVM system 100. Preferably, continuous vacuum monitor sump unit 143a is located adjacent to UST 107, preferably within containment sump 140a, as shown. Preferably, continuous vacuum monitor remote unit 143b is remotely located within an adjacent structure 121, as shown. Upon reading this specification, those skilled in the art will now understand that, under appropriate circumstances, considering issues such as cost, efficiency, adjustments to the system arrangement, etc., other system configurations, such as combining logic/control components with product storage and delivery monitoring components within the containment sump may suffice.

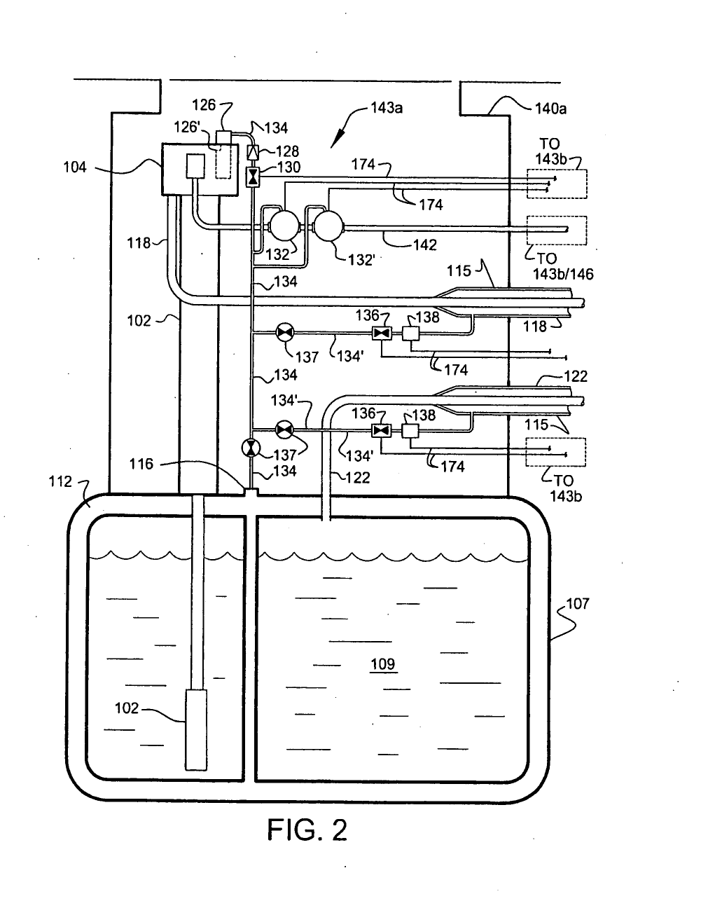

FIG. 2 is a diagram generally illustrating product storage and delivery monitoring components of continuous vacuum monitor sump unit 143a according to the preferred embodiment of FIG. 1. Preferably, continuous vacuum monitor sump unit 143a is accessibly located within containment sump 140a of UST 107, as shown. Upon reading this specification, those skilled in the art will now understand that, under appropriate circumstances, considering issues such as cost, efficiency, adjustments to the system arrangement, etc., other locations for continuous vacuum monitor sump unit 143a, may suffice.

Preferably, CVM system 100 utilizes an unregulated vacuum source generated within the functioning element of STP 102 to produce the system-monitoring vacuum. Standard submersible turbine pumps, used within petroleum storage tanks, are generally adaptable to produce a vacuum during operation. As an example, properly fitted one-third to two horsepower STP units produced by FE Petro Inc. of McFarland, Wis., U.S.A. are capable of producing an unregulated vacuum while operating of about 272-381 inches water column (20-28 inches HG). To utilize STP 102 as a preferred vacuum generator for CVM system 100, vacuum transfer line 134 is preferably connected to an internal vacuum pump 126′. Preferably, internal vacuum pump 126′ comprises a pump utilizing the Bernoulli effect, preferably a venturi vacuum pump (at least herein embodying wherein such at least one gas pressure setter comprises at least one fluid flow system adapted to provide, essentially by Bernoulli effect, such at least one combined level of gas pressure). Preferably, vacuum pump 126′ is in fluid communication with external vacuum port 126, located at STP head 104, as shown.

Preferably, systems not having a readily adaptable submerged turbine pump may preferably utilize an independent vacuum pump device utilizing the Bernoulli effect. It is noted that the configuration and operation of such vacuum pump devices are described in greater detail in the applicants U.S. Pat. No. 6,044,873 to Miller, incorporated herein by reference as prior art to enable, in conjunction with this specification, applicant's continuous vacuum monitoring system.

Preferably, vacuum transfer line 134 comprises a hollow cylindrical pipe. Preferably, vacuum transfer line 134 comprises a rigid metallic pipe, preferably a rigid copper pipe when situated within the protective housing of continuous vacuum monitor sump unit 143a. Preferably, vacuum transfer line 134 comprises a flexible nylon, fuel-inert tubing, when routed external to the protective housing of continuous vacuum monitor sump unit 143a. Preferably, vacuum transfer line 134 utilizes a nominal diameter of about 0.25 inches. Preferably, vacuum transfer line 134 extends to liquid check valve 128, preferably, used to prevent product 109 from entering the downstream components of CVM system 100 (in the event of an internal STP seal failure). From liquid check valve 128, vacuum transfer line 134 extends to vacuum control valve 130 used to regulate the vacuum flow between vacuum port 126 and any secondary containment space 112 in fluid communication with vacuum transfer line 134. Preferably, vacuum control valve 130 comprises a solenoid valve, preferably a 2-way solenoid valve, preferably a 2-way, normally closed solenoid valve. Preferably, vacuum control valve 130 comprises a U.L. approved, 110-120 VAC, intrinsically safe, 2-way, normally closed solenoid valve generally matching the specification of model WBIS8262A320/AC produced by ASCO Valve of Florham Park, N.J., U.S.A.

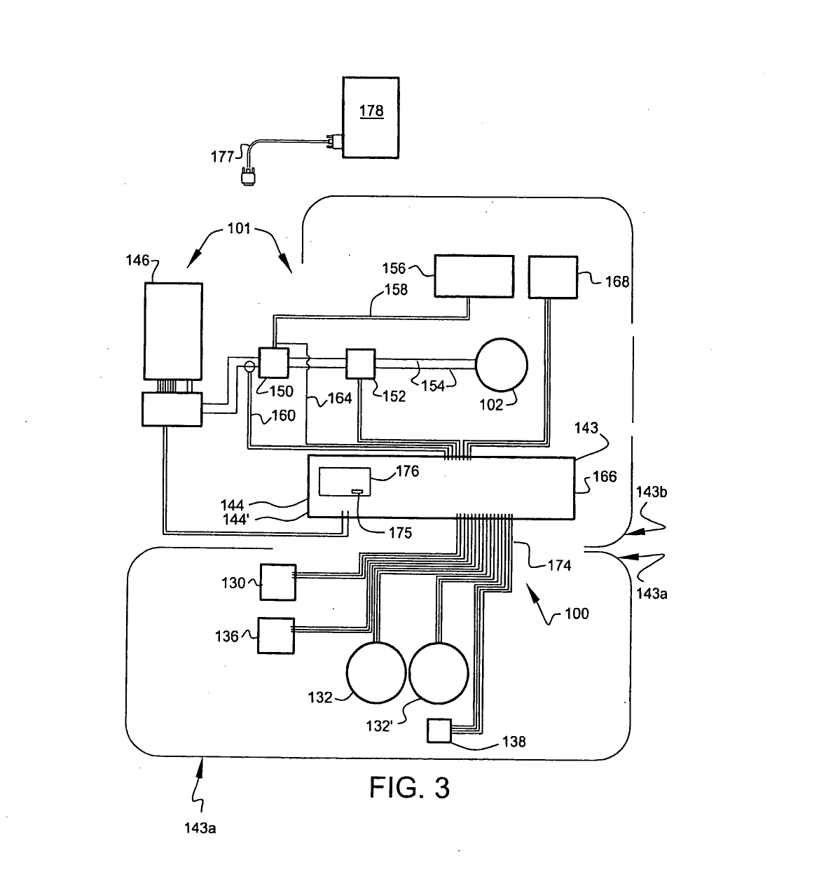

Preferably, vacuum control valve 130 is electrically coupled to a remotely located continuous vacuum monitor remote unit 143b (see FIG. 3). Preferably, vacuum control valve 130 is controlled by continuous vacuum monitor remote unit 143b (see FIG. 3). Preferably, vacuum control valve 130 is electrically coupled and controlled by continuous vacuum monitor remote unit 143b (see FIG. 3) From vacuum control valve 130, vacuum transfer line 134 preferably passes through secondary tank 116 such that the interior of vacuum transfer line 134 is in fluid communication with secondary containment space 112, as shown. In installations having multiple monitored secondary containment space(s) 112, one or more isolation ball valve(s) 137 are preferably used to facilitate system maintenance and diagnostic assessment of the system, as shown.

Preferably, low differential pressure switch 132 is connected “on-line” to vacuum transfer line 134 and continuously monitors the resident vacuum within any secondary containment space(s) 112 in fluid communication with vacuum transfer line 134. Low differential pressure switch 132 (as shown in FIG. 3) is preferably calibrated with high and low vacuum settings allowing for adjustable threshold setting, vacuum regulation and control of vacuum applied to secondary containment space 112. Preferably, low differential pressure switch 132 triggers on detection of the preset high and low vacuum thresholds. Preferably, low differential pressure switch 132 comprises an explosion-proof differential pressure switch. Preferably, low differential pressure switch 132 comprises a U.L. Approved explosion-proof differential pressure switch generally matching the specification of the series 1950 units produced by Dyer Instruments, Inc. of Michigan City, Ind., U.S.A. Preferably, low differential pressure switch 132 is arranged for electrical communication with continuous vacuum monitor remote unit 143b (see FIG. 3). Under appropriate circumstances, such as for secondary containment monitoring installations requiring periodic high vacuum testing, CVM system 100 may comprise high differential pressure switch 132′ configured to establish a high vacuum load within secondary containment space 112. Preferably, CVM system 100 may comprise high differential pressure switch 132′ configured to establish a periodic high vacuum load within secondary containment space 112.

Preferably, high differential pressure switch 132′ is arranged for electrical communication with continuous vacuum monitor remote unit 143b (see FIG. 3). Preferably, both low differential pressure switch 132 and high differential pressure switch 132′ are mounted within containment sump 140a using electrical conduit 142 (electrical conduit 142 also containing STP line voltage electrical conductor 154 to supplying power to submerged turbine pump 102), as shown. Upon reading this specification, those skilled in the art will now understand that, under appropriate circumstances, considering issues such as cost, system dimensions, the location of other system components, etc., wiring arrangements, such as routing the interface-wiring between the low differential pressure switch, the high differential pressure switch and the secondary-containment monitor data module through the electrical conduit concurrent with the STP line voltage electrical conductor, etc., may suffice.

As described in FIG. 1, CVM system 100 preferably monitors secondary containment space 112 of UST 107. CVM system 100 preferably monitors any associated double contained piping 115 and containment sumps within product storage and delivery system 101. Depending on the monitoring options selected, CVM system 100 preferably permits secondary containment space(s) 112 to be monitored as a single containment space. Depending on the monitoring options selected, CVM system 100 preferably permits secondary containment space(s) 112 to be monitored as a combined containment space. FIG. 2 illustrates preferred vacuum connection arrangements to primary product delivery line 118 and primary tank vent line 122, as shown. Although a single tank return line (tank vent line 122) is depicted, those skilled in the art, upon reading the teachings of this specification, will appreciate that, under appropriate circumstances, considering issues such as stored product type and regulatory requirements, the monitoring of other double contained piping, such as double contained product vapor recovery lines, double contained ventilation lines, non-single contained piping, etc, is within the scope of the present invention. Further, it will be clear to those skilled in the art, that the diagrammatic designs described for primary product delivery line 118 and primary tank vent line 122 are readily applicable to wide range of multi-contained piping arrangements, including secondary contained piping arrangements.

Preferably, vacuum branch line 134′ extends between vacuum transfer line 134 and secondary containment space 112 of primary product line 118, as shown. Preferably, CVM system 100 comprises an inline hydrocarbon/liquid sensor 138 adapted to return data to continuous vacuum monitor remote unit 143b, as shown. Additionally, CVM system 100 further preferably comprises solenoid operated isolation control valve 136 adapted to isolate secondary containment space 112 of primary product delivery line 118 from other secondary containment space(s) 112 within the monitoring scope of CVM system 100. Preferably, isolation control valve 136 matches the specification of vacuum control valve 130. Preferably, isolation control valve 136 is controlled by continuous vacuum monitor remote unit 143b, in a substantially similar manner as vacuum control valve 130 (see FIG. 3). Preferably, vacuum connection 131 of vacuum branch line 134′ is positioned below secondary containment boundary 110 to facilitate the draining of collected liquids to hydrocarbon/liquid sensor 138, as shown. The above described CVM system 100 monitoring arrangement for primary product delivery line 118 is essentially identical in its application to primary tank vent line 122, as shown. Upon reading this specification, those skilled in the art will now understand that, under appropriate circumstances, considering issues such as cost, efficiency, adjustments to the system arrangement, etc., other configurations involving vacuum transfer line 134 may suffice, such as, for example, the extension of vacuum transfer lines to other double containment assemblies such as adjacent containment sumps, product lines, vapor lines, etc.

Typically, during installation of system 101 (see FIG. 1), various amounts of material contaminants enter secondary containment space 112. In another preferred feature of the present invention, CVM system 100 is adapted to remove substantially all loose material contaminants from secondary containment space(s) 112. Preferably, CVM system 100 is adapted to remove substantially all liquids from secondary containment spaces. Preferably, on start-up, the high vacuum generated by CVM system 100 is used to purge the contents of secondary containment space(s) 112 thereby greatly reducing potential system failures caused by residual interstitial liquid contaminants.

In a properly installed/maintained secondary containment system, once a resident vacuum is established by CVM system 100 within secondary containment space 112, the gas pressure level will remain constant until relieved. Preferably, CVM system 100 senses resident vacuum between high and low “preset” thresholds. Preferably, CVM system 100 responds with an alarm if the resident vacuum changes beyond a predetermined amount. Preferably, CVM system 100 responds with an alarm if the resident vacuum cannot be maintained. In the design and operation of CVM system 100, it is assumed that the tank and piping secondary containment space(s) 112 of product storage and delivery system 101 are manufactured and installed to a degree of acceptable vacuum integrity. CVM system 100 is preferably configurable to account for natural pressure changes. Preferably, CVM system 100 is configurable to account for long-term secondary containment permeability.

FIG. 3 is a diagram generally illustrating the electrical sensing, control, data logging and alert components of CVM system 100 according to the preferred embodiment of FIG. 1.

To fully explain the preferred embodiments of CVM system 100, product storage and delivery system 101, of FIG. 3, includes “typical” fuel management components common to most fuel handling systems. Preferably, these “typical” components can be arranged to work in conjunction with the present invention but are, by preference, not generally part of the preferred embodiments. As previously discussed in FIG. 1, these “typical components” include; breaker panel 146, submerged turbine pump 102, STP relay 150 (a normally open, double pull/double throw switch to regulate the flow of electrical power between breaker panel 146 and submerged turbine pump 102), STP line voltage electrical conductor 154 and reset enable controller 156 (used to control STP relay 150). This “typical component” arrangement may be found, for example, within small neighborhood gas stations and larger vehicle fueling sites.

The basic operation of product storage and delivery system 101 is relatively straightforward. To provide product to a dispenser (see FIG. 1), a low voltage trigger signal is sent by reset/enable controller 156, via reset enable control line 158, to close STP relay 150, thus permitting a flow of line voltage current to power STP 102. As previously discussed, CVM system 100 consists of two principal components comprising continuous vacuum monitor sump unit 143a (preferably located adjacent to UST 107) and continuous vacuum monitor remote unit 143b (preferably located within an adjacent structure). Preferably, continuous vacuum monitor sump unit 143a comprises; vacuum control valve 130, system optional isolation control valve 136, low differential pressure switch 132, optional high differential pressure switch 132′ and optional hydrocarbon/liquid sensor 138, each in electrical communication with continuous vacuum monitor remote unit 143b by means of interface wiring 174, as shown.

Preferably, continuous vacuum monitor remote unit 143b generally comprises leak detect relay 152, STP power monitor line 160 and leak detect control line 164, as shown. Preferably, continuous vacuum monitor remote unit 143b further comprises audiovisual alarm 168 and associated interface wiring, as shown. Preferably, continuous vacuum monitor remote unit 143b comprises main logic unit 144 and control relay assembly 166, as shown. Main LOGIC UNIT 144 preferably comprises a data logging component 144′ configured to record and store system performance data over time. Upon reading this specification, those skilled in the art will now understand that, under appropriate circumstances, considering issues such as cost, efficiency, and system requirements, other combinations of continuous vacuum monitor remote unit 143b, may suffice, such as, for example, combining a remote-type-unit functions within the sump unit.

Leak detect relay 152 preferably regulates electrical current flow within STP line voltage electrical supply 154 and is preferably located in series with STP relay 150, as shown. Preferably, leak detect relay 152 is electrically coupled to control relay assembly 166 by leak detect control line 164, as shown. Preferably, leak detect relay 152 is configured to be normally closed, but is otherwise substantially identical in specification to STP relay 150.

Preferably, STP power monitor line 160 is adapted to provide continuous vacuum monitor remote unit 143b with an indication of current flow within STP line voltage electrical supply 154. Preferably, reset enable monitor line provides continuous vacuum monitor remote unit 143b with an indication of the presence of a low voltage trigger signal at STP relay 150.

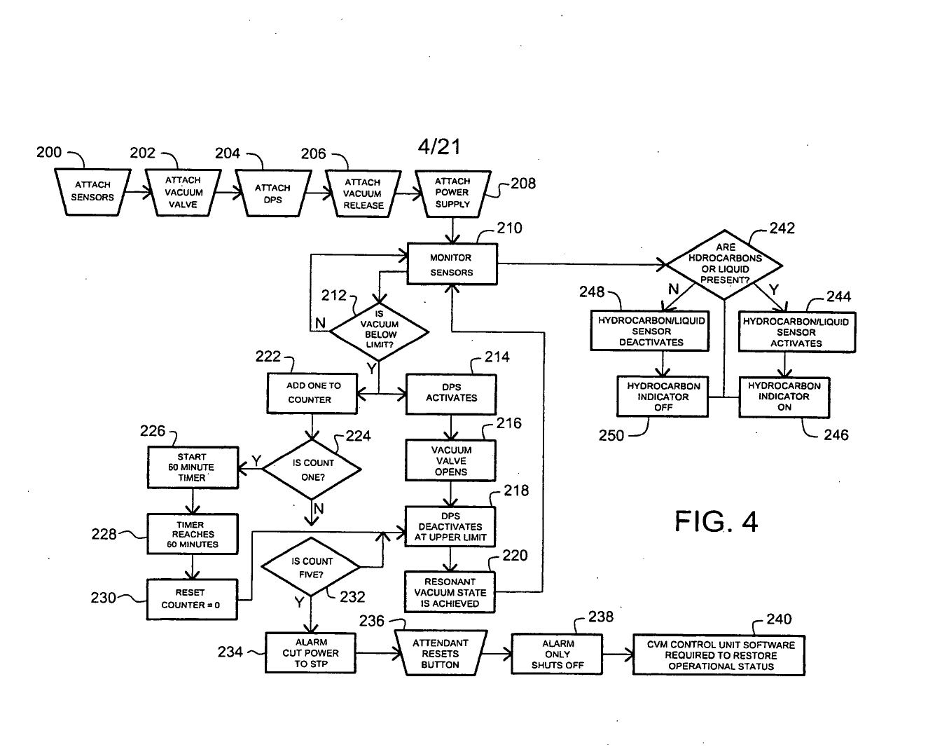

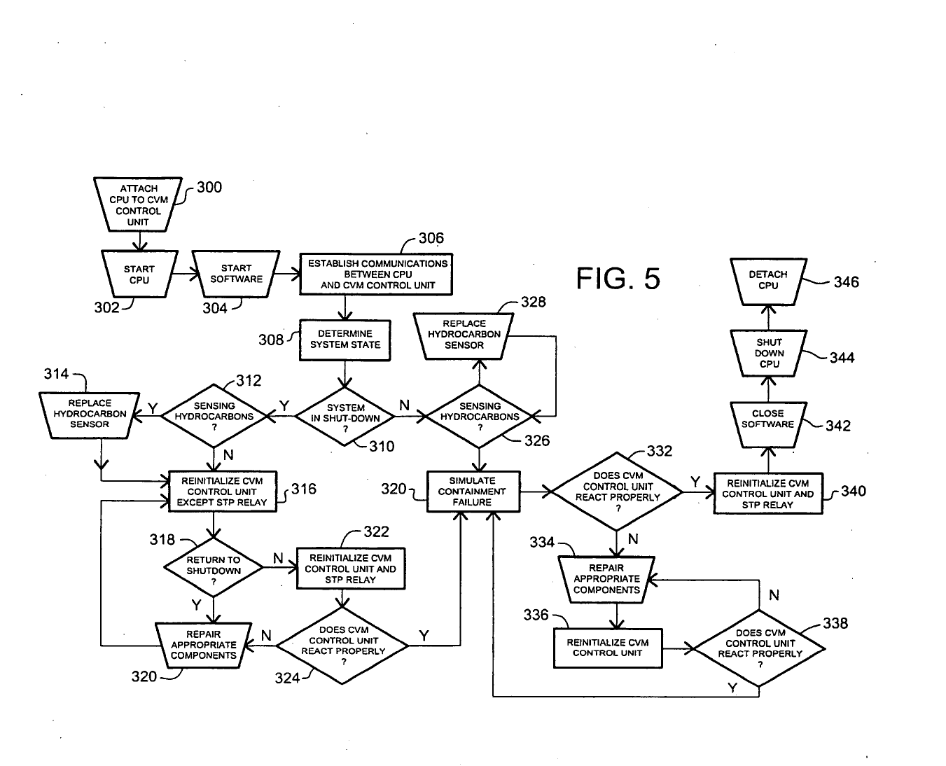

The preferred operation of CVM system 100 is generally described in FIG. 4 and FIG. 5 below. Preferably, continuous vacuum monitor remote unit 143b, on determining that a secondary containment failure has occurred (based on a change in vacuum within secondary containment space 112 or other implemented senor indications), triggers leak detect relay 152 to open, thereby severing power to STP 102. On severing power to STP 102 continuous vacuum monitor remote unit 143b may, under appropriate circumstances, close vacuum control valve 130 to protectively isolate secondary containment space 112.

Preferably, continuous vacuum monitor remote unit 143b is adapted to contemporaneously monitor STP relay 150. Preferably, continuous vacuum monitor remote unit 143b is adapted to contemporaneously monitor STP relay 150 for the presence of a signal generated by reset/enable controller 156, and line voltage current. Preferably, continuous vacuum monitor remote unit 143b is adapted to contemporaneously monitor, STP relay 150 for the presence of a signal generated by reset/enable controller 156, and line voltage current (typically 240 v 3phase) flowing between breaker panel 146 and STP 102. Preferably, the signal generated is a low voltage signal. Detection by continuous vacuum monitor remote unit 143b of the low voltage signal at STP relay 150 in the absence of line voltage current flow between breaker panel 146 and STP 102 (for example, after continuous vacuum monitor remote unit 143b has opened leak detect relay 152) preferably initiates an alarm, preferably utilizing audiovisual alarm 168.

To assist in system operation and management, continuous vacuum monitor remote unit 143b preferably comprises SCM control panel 176, as shown. SCM control panel 176 preferably comprises system specific user interface components such as, system status indicators, system power on/off switches, system reset switches and logic data port 175.

Preferably, continuous vacuum monitor remote unit 143b comprises an integral data logging component 144′, preferably to record monitoring events during the operation of CVM system 100. This data is preferably used by main LOGIC UNIT 144 to respond to trends in system behavior based on preset pressure profiles. Preferably, the data is used to assess the operational status of the secondary containment components to establish if a system pressure trend exceeds the preset profile therefore warranting an alarm and shutdown. Preferably, the data gathered and stored by data logging component 144′ is also utilized by a CVM system 100 service technician or trained alarm response person (TARP) as a diagnostic tool in assessing the operational status of CVM system 100. Those skilled in the art, upon reading the teachings of this specification, will appreciate that, under appropriate circumstances, considering issues such as system cost, efficiency, intended application, etc, other data assessment methods, such as the use of commercially available data logging/supervisory control devices in combination with LABVIEW® (National Instruments Corporation of Austin, Tex.), commercial logging/control software, etc., may suffice.

Those skilled in the art, upon reading the teachings of this specification, will appreciate that, under appropriate circumstances, considering issues such as system location, monitoring requirements, etc., other methods of data monitoring, such as site remote data monitoring using dialer and/or modem components adapted to transmit system performance data to a remote monitoring site, etc., may suffice. For example, a central alarm response station may preferably be established to remotely monitor a plurality of sites, within a region, whereby each of the sites comprises a product storage and delivery system monitored by CVM system 100. Preferably, CVM system 100 comprises at least one modem 560.

Preferably, CVM system 100, on detecting a problem within the secondary containment, transmits an alarm signal to the central alarm response station. Depending on the preferred configuration of CVM system 100, the functions of main LOGIC UNIT 144 and data logging component 144′ may, under appropriate circumstances, be located at the central alarm response station.

In monitored systems having low product/STP demand, it is preferred that CVM system 100 be capable of independently starting STP 102 to re-establish vacuum within secondary containment space 112 during programmed monitoring cycles. This preferred embodiment of CVM system 100 comprises a modification to STP power monitor line 160 permitting continuous vacuum monitor remote unit 143b to periodically close STP relay 150.

FIG. 4 is a Data Module Flow Chart for CVM system 100 according to a preferred embodiment of the present invention. FIG. 4 depicts the normal set-up and operation of CVM system 100. Initially, as shown in steps 200, 202, 204, 206, and 208, continuous vacuum monitor remote unit 143b (hereafter also referred to as CVM remote unit 143b) is preferably connected to various sensors, valves, and power supply to affect CVM remote unit 143b monitoring operation, as shown in step 210. Step 200 depicts the CVM remote unit 143b connection to hydrocarbon/liquid sensor 138. This connection is optionally connected for site-specific preferred embodiments of CVM system 100. Step 202 depicts the vacuum control valve 130 connection to CVM remote unit 143b. As shown, step 204 depicts the connection between CVM remote unit 143b and low differential pressure switch 132. Another optional (site-specific) connection in the set-up of CVM system 100 is between the CVM remote unit 143b and isolation control valve 136, as shown in step 206. Step 208 shows the low voltage power supply from breaker panel 146 to CVM remote unit 143b, hydrocarbon/liquid sensor 138, vacuum control valve 130, low differential pressure switch 132, and the isolation control valve 136. Upon reading this specification, those skilled in the art will now understand that, under appropriate circumstances, considering issues such as cost, efficiency, adjustments to the system arrangement, etc., other set-up sequences, may suffice, for example, installation of the system may include set-ups using additional sensors, mounting kits, conduits, seals, etc.

The continuous monitoring of the resident vacuum in secondary containment space 112 is preferably performed by low differential pressure switch 132. Preferably, a low limit pressure set point, dependent on the individual tank system, is preset into low differential pressure switch 132. Preferably, the vacuum in secondary containment space 112 is monitored, as shown in step 212. Preferably, the vacuum in secondary containment space 112 is monitored based on the level of resident vacuum within secondary containment space 112. Preferably, if a vacuum pressure is detected that is different from the preset pressure set point, the CVM remote unit 143b continues to monitor the system. Preferably, if a vacuum pressure is detected that is higher than the preset low limit pressure set point, the CVM remote unit 143b continues to monitor the system, as shown in step 210. Preferably, if a vacuum pressure is detected that is lower than the preset low limit pressure set point, as indicated in step 212, the low differential pressure switch 132 activates, as shown in step 214. Preferably, the low limit pressure set point is preset at about 4 inches water column (wc).

Preferably, in order for CVM system 100 to continue monitoring, the vacuum in secondary containment space 112 is preferably increased above the low limit pressure set point. Preferably, as indicated in step 216, vacuum control valve 130 is then opened to increase the vacuum in the secondary containment space 112. Preferably, as the vacuum approaches a preset upper pressure limit, shown in step 218, such preset is also approached in low differential pressure switch 132, deactivating low differential pressure switch 132. Preferably, this upper pressure limit is preset at about 30 inches wc. Preferably, the resonant desired vacuum state is achieved in secondary containment space 112, as shown in step 220. Preferably, monitoring by the CVM remote unit 143b continues, as shown in step 210.

Preferably, CVM remote unit 143b has the ability to monitor the pressure changes of the vacuum in secondary containment space 112. Preferably, CVM remote unit 143b has the ability to monitor the number of times, within a given time period, that the vacuum in secondary containment space 112 falls below the preset lower limit. Preferably, CVM remote unit 143b has the ability to monitor the number of times, preferably utilizing a counter, that the vacuum in secondary containment space 112 falls below the preset lower limit. Preferably, if a vacuum pressure is detected that is lower than the preset low limit pressure set point, one unit is added to the counter in the CVM remote unit 143b, as shown in step 224. Preferably, at startup, the CVM remote unit 143b counter is set at zero, as shown in step 222.

Preferably, if the count is equal to one (step 224), a timer is initiated in CVM remote unit 143b, as indicated in step 226. Preferably, the timer is, as shown in step 226, a sixty-minute timer. Preferably, the timer continues to time, as shown in step 228, until the sixty minutes is reached. When the sixty minutes time has run, the timer is preferably reset to zero, as shown in step 230. Preferably, if the low limit pressure set point counter, as shown in step 222, has not counted five lower limit secondary containment space 112 vacuum detections, and the timer is reset to zero (the sixty minutes has run), then low differential pressure switch 132 is deactivated and the alarm is off, as shown in step 218.

Preferably, if the low limit pressure set point counter, as shown in step 222, has counted five lower limit secondary containment space 112 vacuum detections, as indicated in step 232, within the sixty-minute time, CVM remote unit 143b breaks the power to STP 102 and also breaks the power to vacuum control valve 130, as shown in step 234. Preferably, at such time that step 234 is initiated, an alarm, preferably a locked alarm, would actuate as a remote audio-visual alarm (AVA) 168. Preferably, the locked alarm is reset by an attendant or TARP, as shown in step 236. Preferably, (as indicated in step 238) only the alarm is cleared (shut off). In order to restore CVM system 100 to normal operation, it is necessary to troubleshoot the system at SCM Control Panel 176, as indicated in step 240.

If a hydrocarbon/liquid sensor 138 is provided with CVM system 100, it is preferably monitored by the CVM remote unit 143b, as shown in step 242. If the presence of hydrocarbons or liquid is sensed in secondary containment space 112, the hydrocarbon/liquid sensor 138 preferably activates (step 244) and a remote indicator light is turned on (step 246). Step 248 indicates that if no hydrocarbons or liquid is sensed in the secondary containment space 112, then hydrocarbon/liquid sensor 138 is preferably not activated and the remote indicator light does not illuminate, or simply turns off.

FIG. 5 is a Control Panel Software Flow Chart for CVM system 100 according to a preferred embodiment of the present invention. FIG. 5 provides the process that is preferably used to restore CVM system 100 to operational status after the power has shut off to the submerged turbine pump 102 and the vacuum control valve 130, as shown in step 234 of FIG. 4. Preferably, a separate diagnostic CPU 178 is used to evaluate the status of CVM system 100 and reinitialize, as necessary. Preferably, the diagnostic evaluation is also used if there is a component failure in the CVM system 100. Upon reading this specification, those skilled in the art will now understand that, under appropriate circumstances, considering issues such as cost, efficiency, adjustments to the system configuration, etc., other techniques of evaluating the status of system 100, may suffice.

Typically a TARP, having the appropriate diagnostic CPU 178 (see FIG. 3), is required to be contacted so that, as shown in step 300, the diagnostic CPU 178 can preferably be attached to the CVM remote unit 143b, preferably via a data cable 177 connection, preferably to data port 175 (see FIG. 3). After the diagnostic CPU is attached, both diagnostic CPU 178 (step 302) and the SCM Control Panel 176 software (step 304) are started. Preferably, data communication between diagnostic CPU 178 and CVM remote unit 143b is then established, as in step 306. Preferably, as shown instep 308, once data communication is established, the state of the CVM remote unit 143b is determined. Upon reading this specification, those skilled in the art will now understand that, under appropriate circumstances, considering issues such as cost, efficiency, adjustments to the system configuration, etc., other techniques of establishing data communication, may suffice, for example, CVM remote unit 143b may preferably comprise a modem or IR communication ability for remote diagnostic testing.

Preferably, the initial step 310 of the diagnostic process involves determining if CVM remote unit 143b is in STP 102 shut down mode. If it is, as shown in step 312, preferably it is then determined if the hydrocarbon/liquid sensor 138 was activated. Preferably, if the hydrocarbon/liquid sensor 138 was activated, the sensor should be replaced, as shown in step 314. Preferably, if hydrocarbon/liquid sensor 138 was not activated then CVM remote unit 143b, except for STP relay 150, is reinitialized, as indicated in step 316. Preferably, after CVM remote unit 143b is reinitialized, it should be determined whether CVM remote unit 143b returned to STP 102 shut down mode, as shown in step 318. If, after reinitialization, CVM remote unit 143b does return to STP 102 shut down mode, it is an indication that components of the system may have failed and it is necessary to repair the appropriate components, as shown in step 320. After the appropriate repairs have been performed, it is necessary to repeat step 316 and reinitialize CVM remote unit 143b except for STP relay 150. Upon reading this specification, those skilled in the art will now understand that, under appropriate circumstances, considering issues such as cost, efficiency, adjustments to the system configuration, etc., other combinations of reinitialization steps, may suffice.

If, after reinitialization of CVM remote unit 143b (as shown in step 316), CVM remote unit 143b has not return to STP 102 shut down mode, CVM remote unit 143b and STP relay 150 are preferably reinitialized, as provided for in step 322. Step 324 preferably requires, after reinitialization (step 322), that CVM remote unit 143b be evaluated by the TARP performing the diagnostics as to appropriate operation/reaction. If it is determined that CVM remote unit 143b is not operating appropriately, then appropriate components preferably are repaired, as shown in step 320. Again, after component repair, it is necessary to repeat step 316, 318, 322, and 320 as necessary, until CVM remote unit 143b is determined to operate properly.

Once the TARP determines that the CVM remote unit 143b is operating/reacting appropriately step 330 is performed. Step 330 includes the simulation of a secondary containment failure. The steps following the simulation of the secondary containment failure are discussed in greater detail in the following discussion.

Preferably, the initial step 310 of the diagnostic process involves determining if CVM remote unit 143b is in STP 102 shut down mode. Preferably if it is not in STP 102 shut down mode, as shown in step 326, it is then determined if hydrocarbon/liquid sensor 138 was activated. If hydrocarbon/liquid sensor 138 was activated, it is necessary to replace the sensor, step 328. Preferably, if hydrocarbon/liquid sensor 138 was not activated then, as provided in step 330, the TARP simulates a secondary containment failure. Preferably, after simulation of the secondary containment failure, CVM remote unit 143b is evaluated by the TARP performing the diagnostics as to appropriate operation/reaction. If it is determined that CVM remote unit 143b is not operating appropriately, then it is necessary to repair appropriate components, as shown in step 334. After component repair, it is necessary to reinitialize CVM remote unit 143b (step 336) and have the TARP reevaluate, as indicated in step 338, the appropriate operation/reaction of CVM remote unit 143b. If the CVM remote unit 143b does not operate/react appropriately, then it is necessary to repeat steps 334, 336, and 338, as necessary, until the CVM remote unit 143b is determined to operate properly.

Preferably, once CVM remote unit 143b is determined to operate properly, the TARP is to repeat step 330, the simulation of the secondary containment failure, and step 332. After the simulation is performed and CVM remote unit 143b is determined to be operating/reacting properly, step 332, CVM remote unit 143b and STP relay 150 are reinitialized, as in step 340.

Preferably, after the reinitialization of CVM remote unit 143b and STP relay 150, as shown in step 340, the diagnostics are essentially completed. Steps 342, 344 and 346 preferably involve closing SCM Control Panel 176 software, shutting down the diagnostic CPU 178, and disconnecting the data cable 177 from data port 175 of diagnostic CPU 178 and CVM remote unit 143b.

Preferably, all embodiments of CVM system 100 comprise arrangements substantially consisting of “stock” components. In the present disclosure, the term “stock” shall be understood to define those readily available components having an appropriate testing approval, such as those components carrying a UL listing.

Upon reading this specification, those skilled in the art will now understand that, under appropriate circumstances, considering issues such as efficiency, adjustments to the system configuration, etc., other methods of completing the diagnostics, such as remote data acquisition and analysis, not using a TARP, etc., may suffice.

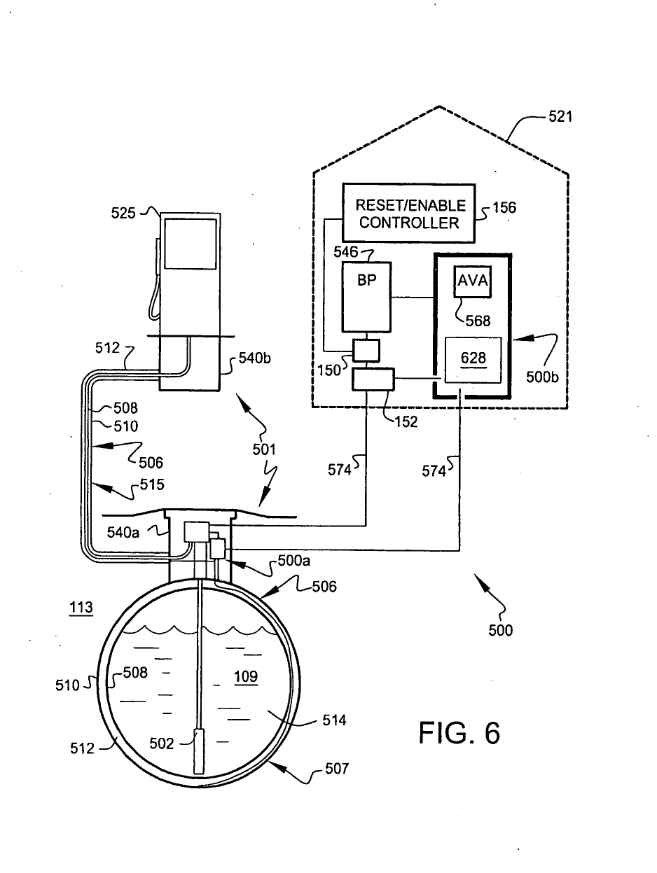

FIG. 6 is a diagram generally illustrating the operating principles and component arrangements of CVM system 500 (herein after referred to as CVM system 500) according to another preferred embodiment of the present invention. Preferably, CVM system 500 comprises a leak detection and prevention system preferably adapted to continuously monitor the interstitial space of a double-wall environmentally hazardous material handling system. CVM system 500 preferably establishes and monitors a resident gas-pressure within the interstitial secondary containment space 512 to monitor the integrity of the primary and secondary containment boundaries. CVM system 500 detected deviations in resident gas-pressure, in excess of a calibrated vacuum flow rate, or the presence of liquid in any monitored interstice, preferably initiates a system alarm (at least herein embodying monitoring means for essentially-continuous monitoring of such combined interstitial space means to detect deviations from such set at least one combined level of gas pressure). Preferably, once an alarm is signaled, the environmentally hazardous material delivery systems are shut down and an audio-visual alarm is activated in close proximity to operating personnel. Preferably, an onsite service call by qualified personnel is required to return the system back into service.

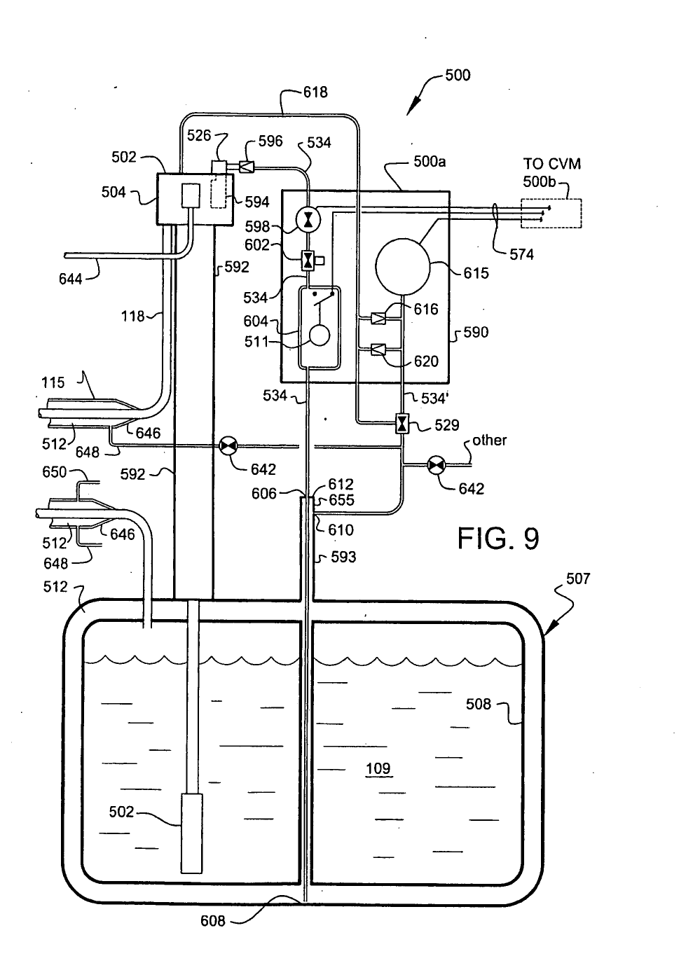

Preferably, monitoring equipment of CVM system 500 is designed to continuously monitor the secondary containment space 512 of product container 506, as shown. Preferably, CVM system 500 is designed to continuously monitor the secondary containment space 512 of product container 506 by setting and monitoring a resident vacuum within the interstitial secondary containment spaces (at least herein embodying gas-pressure setting means for setting at least one combined level of gas pressure in such combined interstitial space means substantially less than at least one tank level of gas pressure in such tank means and substantially less than at least one piping level of gas pressure in such piping means and further at least embodying herein monitoring means for essentially-continuous monitoring of such combined interstitial-space means). As in the prior embodiments, product container 506 may comprise a hydrocarbon fuel storage tank such as UST 507, double contained product line 515, vapor recovery line 520, tank vent lines (see FIG. 9), tank sumps 540a, dispenser sumps 540b and product dispensers 525, as shown. Preferably, CVM system 500 establishes and monitors a resident vacuum within secondary containment space 512 (at least herein embodying tank interstitial space means, interstitial between such tank means and such tank envelope means, for secondary containment of such environmentally-hazardous petroleum products) of product container 506 to continuously monitor and verify the integrity of primary containment boundaries 508 and secondary containment boundaries 510 (at least herein embodying tank envelope means for essentially enveloping such tank means), as shown. Preferably, CVM system 500 establishes and monitors a resident vacuum within secondary containment space 512 (at least herein embodying piping interstitial space means, interstitial between such piping means and such piping envelope means, for secondary containment of such environmentally-hazardous petroleum products) of double contained product line 515 to continuously monitor and verify the integrity of primary containment boundaries 508 and secondary containment boundaries 510 (at least herein embodying piping envelope means for essentially enveloping such piping means), as shown.

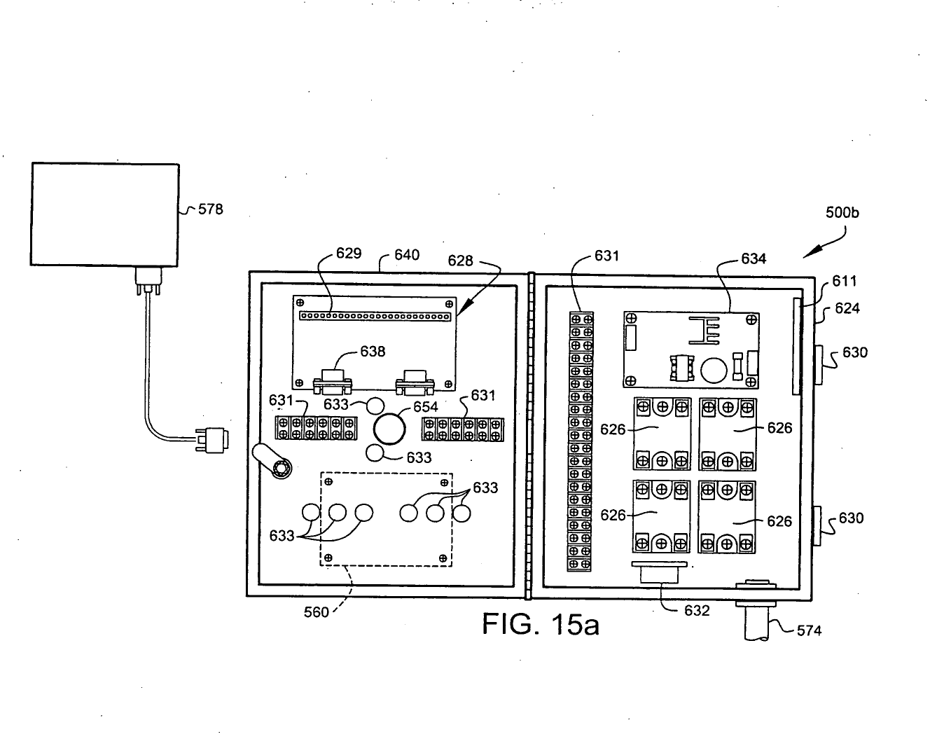

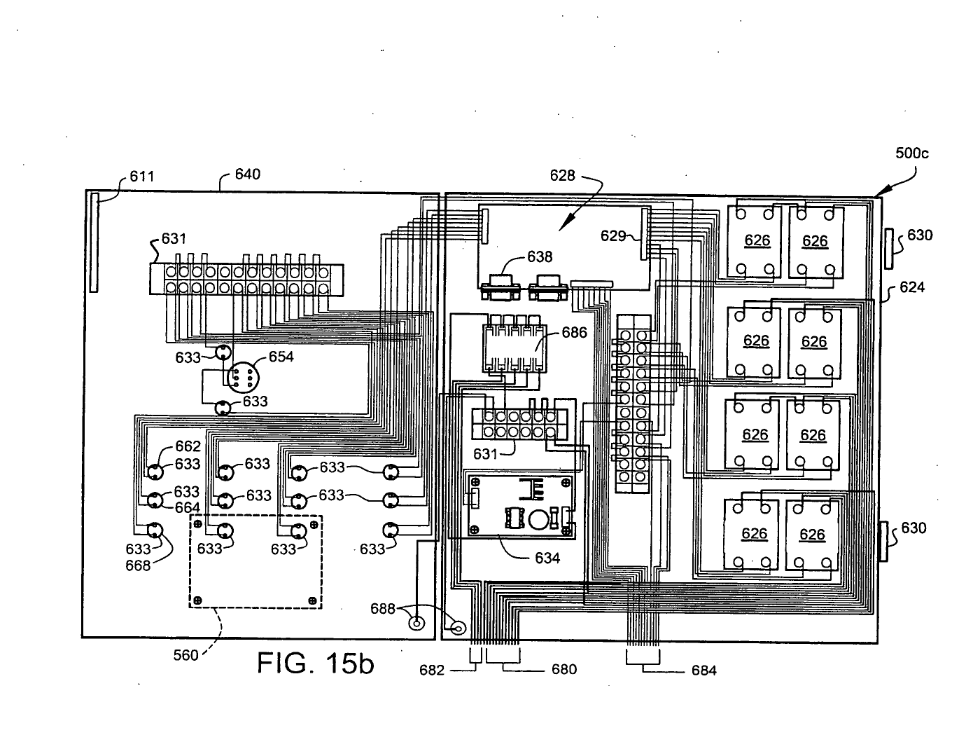

Loss of resident interstitial vacuum in excess of a pre-set rate or the detection of the presence of liquid within any of the secondary containment spaces 512 monitored by CVM system 500 preferably causes CVM system 500 to alarm. Once an alarm condition is signaled, STP 502 is shut down (at least herein embodying wherein such at least one monitor comprises at least one alarm signal adapted to turn off such at least one pump) and an audio-visual alarm (hereinafter referred to as AVA 568) is activated to alert operating personnel of a potential containment problem. Preferably, an onsite service call by qualified personnel is required to bring product storage and delivery system 501 back into normal service. Preferably, a qualified service technician will connect to communication port 575 on system logic unit 628 (see also FIG. 15) to evaluate the cause of the failure. Preferably, CVM system 500 is adaptable to assist in preventing further leakage by evacuating liquid from secondary containment space 512. Preferably, CVM system 500 is adaptable, by means of software programming, to return the extracted interstitial liquids to primary tank 514.

Preferably, all components carry one or more of the following certifications, listings, ratings and approvals; UL, FM, SA, STI and NWG. Preferably, portions of CVM system 500 located adjacent product container 506 are designed to be intrinsically safe and/or explosion-proof-rated for hazardous locations. Furthermore, commercial embodiments of CVM system 500 are designed and tested to be operational in −25 C to 70 C temperature environments (based on current European Protocol). Preferably, CVM system 500 is adaptable to be distributed and sold with governmental authority pre-approvals for secondary containment system monitoring, when CVM system 500 is installed according to a pre-approved manual, using pre-tested and pre-assembled components.

Preferably, CVM system 500 comprises two principle secure and self-contained operational components, as shown. Preferably, CVM system 500 comprises CVM sump unit 500a (at least herein embodying at least one first-components system structured and arranged to have at least one sensory coupling with such combined interstitial space and comprising such at least one gas pressure setter) and CVM remote unit 500b (at least herein embodying at least one second-components system structured and arranged to have at least one signal coupling and at least one control coupling with such at least one first-components system and further at least embodying herein electrical-components means for providing electrical components remotely coupleable with at least one such control-component), as shown. Preferably, CVM remote unit 500b is located within a nearby (or remote) structure 521, as shown (at least herein embodying wherein such at least one second-components system comprises a set of operator-access-locatable elements). Preferably, CVM sump unit 500a is located adjacent to UST 507, as shown (at least herein embodying wherein such at least one first-components system comprises a set of sump-access-locatable elements). Preferably, CVM sump unit 500a and CVM remote unit 500b are electrically coupled, by means of connecting conduits 574, to form the operational CVM system 500, as shown. Preferably, both CVM sump unit 500a and CVM remote unit 500b each comprise securable/lockable housings adapted to prevent unauthorized tampering of internal system components, as shown. Preferably, CVM remote unit 500b is capable of monitoring at least two, preferably four, separate tank and line product storage and delivery systems 501. Preferably, CVM remote unit 500b is modularly expandable to monitor additional tanks using a single common system of connecting conduit 574.

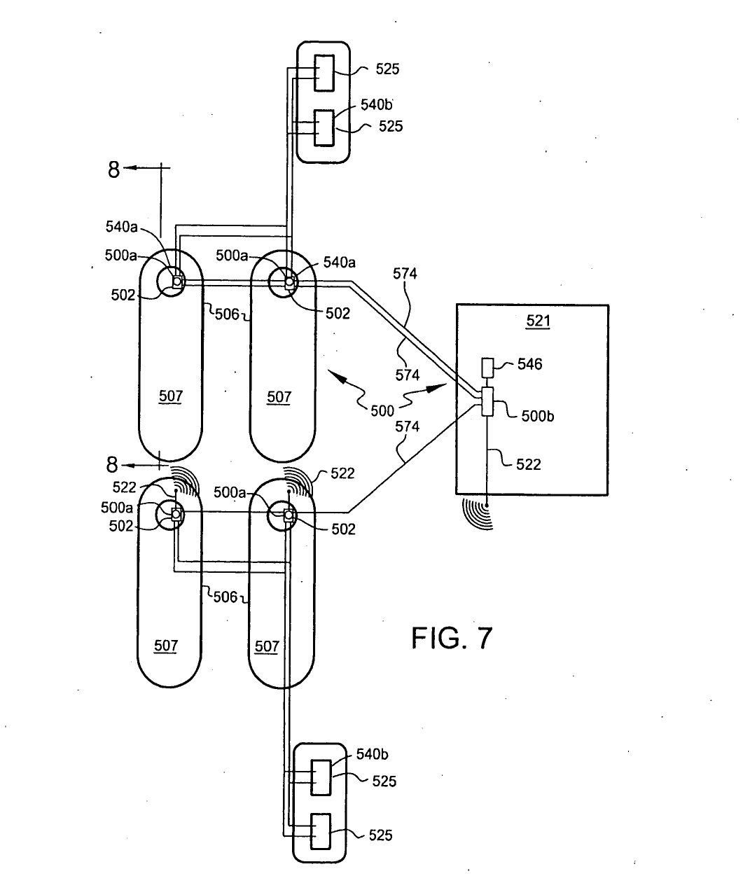

FIG. 7 is a plan view diagrammatically illustrating a typical installation of CVM system 500, within a site, according to the preferred embodiment of FIG. 6. Preferably, CVM sump unit 500a is located within containment sump 540a directly adjacent to STP 502, as shown. Preferably, CVM remote unit 500b is located within an adjacent (or remote) structure 521, as shown. Preferably, CVM remote unit 500b is adapted to monitor one or more isolated or combined secondary containment spaces. Preferably, each CVM remote unit 500b is adapted to simultaneously monitor two to four independent secondary containment spaces, as shown. Preferably, CVM remote unit 500b is modular in design permitting a plurality of CVM remote units to be interconnected along a common data path. A unique advantage of the preferred modular arrangements of CVM remote unit 500b is the ability to interoperate multiple CVM remote units 500b with multiple CVM sump units 500a using a minimal number of interconnecting signal and power conduits, as shown. Upon reading the teachings of this specification, those with ordinary skill in the art will now understand that, under appropriate circumstances, considering issues such as, system application, system cost, etc., other monitoring arrangements may suffice, such as, for example, providing a single remote unit capable of monitoring a large quantity of independent secondary containment spaces.

The preferred configuration for attaching vacuum monitor lines to piping interstice is to have all product, vent, and vapor piping terminate within the STP sumps, such as containment sump 540a, for convenient service access, as shown. When this arrangement is not possible, an alternate preferred configuration comprises utilizing suitable piping as “underground jumpers” to transfer vacuum gas pressure between the interstices of piping located within separate containment sumps. These “jumpers” preferably terminate into the associated STP containment sump as previously described.

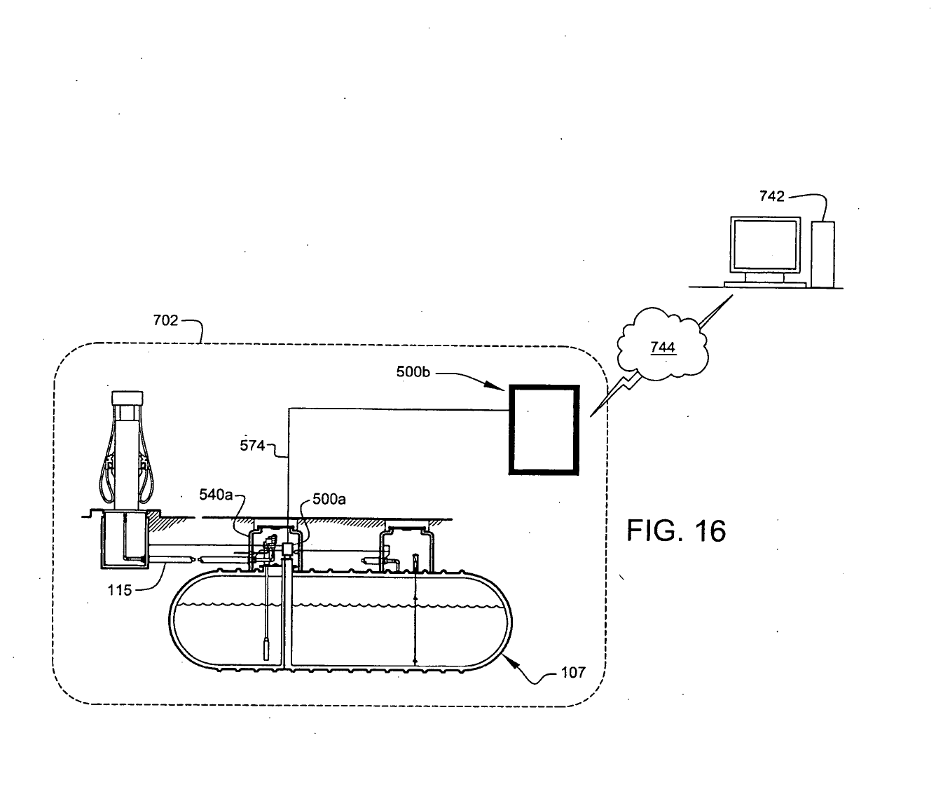

Preferably, CVM system 500 is adaptable to monitor both new and existing facilities. The use of wireless communication technology is preferred where CVM system 500 is retrofitted to an existing product handling facility having the product handling components in place, and where the cost of installing new underground conduit is prohibitive. FIG. 7 illustrates the use of wireless network 522, as shown. Preferably, wireless network 522 (at least herein embodying wherein such at least one electrical-coupling system comprises at least one wireless communicator adapted to wirelessly assist such electrical coupling) is adapted to permit CVM sump unit 500a to transmit signal data to a CVM remote unit 500b by means of a wireless communication connection, as shown. Preferably, wireless network 522 is adapted to permit a bi-directional transfer of data, as shown. Wireless network 522 preferably comprises conventional adaptations of commercially available technologies including systems utilizing, for example, 802.11b (WiFi) wireless LAN standards. Upon reading this specification, those of ordinary skill in the art will understand that, under appropriate circumstances, such as user preference, advances in technology, etc, other wireless arrangements encompassing alternate or newer standards, such as, 802.11a, 802.11g, direct satellite links, etc., may suffice. Where CVM remote units 500b preferably comprises a communication link to a remote site monitoring server (see FIG. 16), CVM remote units 500b preferably serves as an access point to transport data between wireless network 522 and an external network infrastructure.

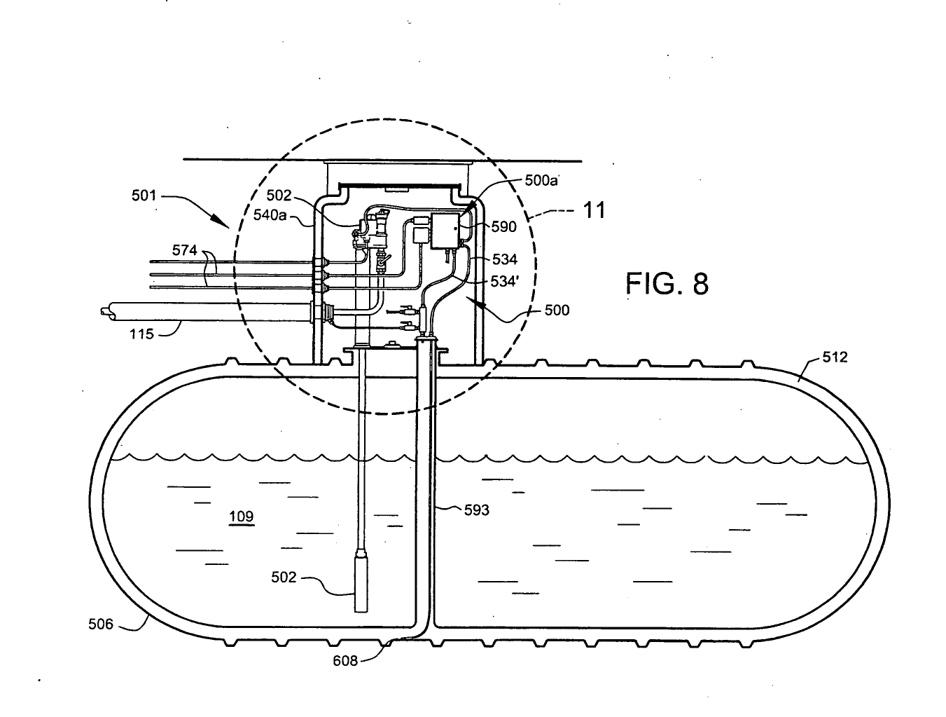

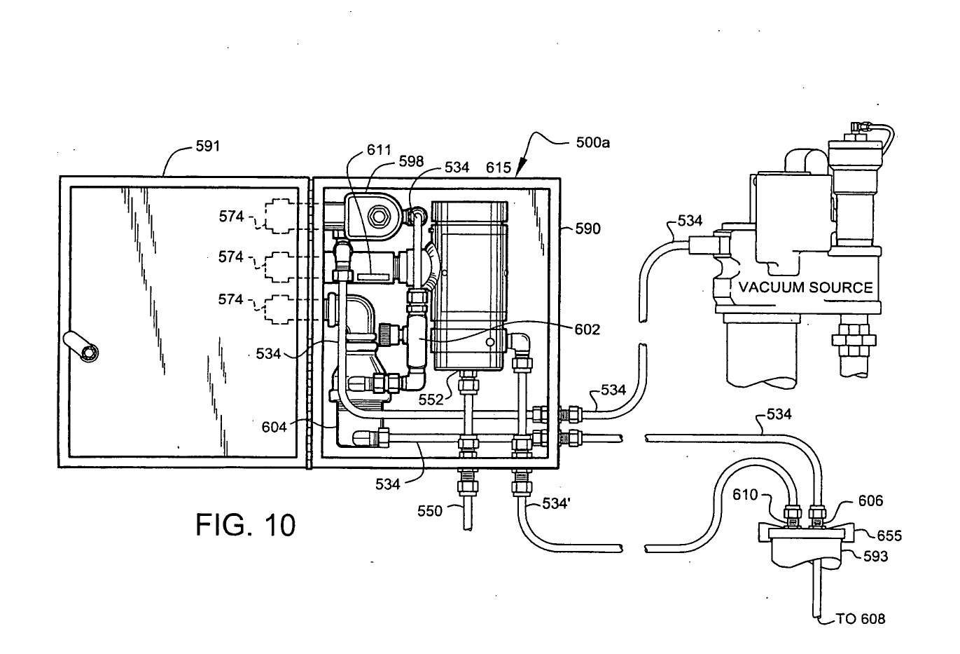

FIG. 8 is a sectional view through the section 8-8 of FIG. 7 diagrammatically illustrating a typical installation of CVM sump unit 500a within a typical product storage tank application, FIG. 9 is a diagram further illustrating a typical installation of CVM sump unit 500a within a typical product storage tank application and FIG. 10 is an interior view of CVM sump unit 500a illustrating a preferred arrangement of operating components according to the preferred embodiments of FIG. 6. For clarity of illustration, not all components of CVM system 500 are depicted in each figure of the disclosure. Referring now to FIG. 8, FIG. 9 and FIG. 10 and with continued reference to the prior figures, CVM sump enclosure 590 preferably comprises means for conveniently grouping, connecting and securely mounting various components of CVM sump unit 500a, as shown. Although each CVM system 500 may comprise physical variations unique to specific product storage and delivery sites, in general, the components of CVM sump unit 500a remain relatively consistent within most monitored applications.

CVM system 500 preferably groups the majority of functioning components of CVM sump unit 500a within CVM sump unit enclosure 590, as shown (at least herein embodying control-components box means for mounting and enclosing such control-components means). This preferred arrangement permits CVM sump unit 500a to be substantially factory pre-assembled and pre-tested, thereby increasing installation efficiencies and system reliability. Preferably, CVM sump unit enclosure 590 comprises an enclosed housing, preferably of rigid metallic construction, having preferred external dimensions of about 14″×12″×6″, as best illustrated in FIG. 10. Preferably, CVM sump unit enclosure 590 comprises a unit manufactured by Hoffman Electric U.S.A. Preferably, CVM sump unit enclosure 590 comprises securable door 591, as shown. Preferably, securable door 591 is both hinged and lockable to prevent unauthorized access of CVM sump unit 500a components, as shown. Preferably, CVM sump unit enclosure 590 is mounted within containment sump 540a using appropriate installation mounting hardware (at least herein embodying geometrical-positioning means for locating such control-components box means adjacent and external to the at least one primary container).

As best illustrated in FIG. 9, system 500 preferably utilizes the unregulated vacuum source generated within STP 502 to produce system-monitoring vacuum.

Primary vacuum source (hereinafter referred to as PVS 594) comprises a vacuum-generating device typically integral to STP head 504, as shown (at least herein embodying wherein such at least one gas pressure setter comprises at least one fluid flow system adapted to provide, essentially by Bernoulli effect, such at least one combined level of gas pressure). Other preferred vacuum generation sources are discussed in FIG. 12, below. Typically, PVS 594 is coupled to a ⅜″ diameter vacuum port 526, as shown. Typically, at least one vacuum port 526 is accessibly located on the exterior housing of STP head 504, as shown. Preferably, CVM system 500 draws vacuum from PVS 594 by means of vacuum port 526, as shown. Preferably, siphon check valve (hereinafter referred to as SCV 596) is installed upstream of PVS 594, in close proximity to vacuum port 526, as shown. Preferably, SCV 596 is connected to vacuum port 526 using a 3/8” diameter steel pipe. Under appropriate circumstances, such as for monitoring applications where CVM system 500 is adapted to quickly remove liquids from secondary containment space 512, SCV 596 may be omitted or may otherwise be supplied as an electrical valve controlled and coordinated by CVM system 500. Preferably, CVM system 500 is coupled to SCV 596/vacuum port 526 by means of vacuum transfer line 534, as shown. Preferably, vacuum transfer line 534 comprises a flexible nylon, fuel-inert tubing. Preferably, vacuum transfer line 534 comprises a nominal diameter of about 0.25 inches, as shown.

Preferably, vacuum transfer line 534, on passing within the protective housing of CVM sump unit 500a, comprises a metallic line. Preferably, vacuum transfer line 534 comprises an essentially rigid metallic line, preferably a copper line, when situated within the protective housing of CVM sump unit 500a. Preferably, vacuum transfer line 534 extends from SCV 596 to a vacuum control valve (hereinafter referred to as VCV 598), as shown. Preferably, VCV 598 is a commercially available, electrically controlled, direct acting solenoid valve, as shown. Preferably, VCV 598 comprises a unit selected from the 7000 series of general purpose two-way direct acting valves as supplied by Parker, Inc. Cleveland, Ohio. Preferably, VCV 598 is installed upstream of and in close proximity to SCV 596, as shown. Preferably, VCV 598 is located within CVM sump unit enclosure 590, as shown. Preferably, VCV 598 is electrically coupled to CVM remote unit 500b by means of connecting conduits 574, extending through CVM sump unit enclosure 590, as shown.

From VCV 598, vacuum transfer line 534 preferably extends to a flow control valve (hereinafter referred to as FCV 602), as shown. Preferably, FCV 602 is installed upstream of and in close proximity to VCV 598, as shown. Preferably, FCV 602 is located within CVM sump unit enclosure 590, as shown. Preferably, FCV 602 permits calibrations to the rate of incoming vacuum pressure. Preferably, FCV 602 reduces the rate at which the high vacuum pressure, generated by the vacuum source, is applied to secondary containment space 512. Preferably, FCV 602 permits the pressure-selling system components of CVM system 500 to react to rising interstitial vacuum, prior to the development pressures beyond the design levels of the, tank, piping or other monitored components. Preferably, FCV 602 (at least herein embodying wherein such at least one gas-pressure-control component comprises at least one gas pressure flow rate restrictor adapted to restrict the rate of gas pressure flow between at least one source of unregulated gas pressure and such at least one interstitial space) comprises a model PF200B flow control valve produced by Parker, Inc. Cleveland, Ohio. Preferably, vacuum transfer line 534 extends from FCV 602 to a liquid sensor chamber (hereinafter referred to as LSC 604), as shown. Preferably, LSC 604 is installed upstream of and in close proximity to FCV 602, as shown. Preferably, LSC 604 is located within CVM sump unit enclosure 590, as shown. Preferably, LSC 604 comprises an enclosed liquid holding vessel containing at least one float switch in electrical communication with CVM remote unit 500b. Preferably, CVM sump unit 500a is adapted to use vacuum generated at STP 502 to draw any leaking liquids from secondary containment space 512, as shown. Preferably, the float switch within LSC 604 is adapted to signal CVM remote unit 500b as a level of liquid within LSC 604 reaches a measurable quantity (at least herein embodying wherein such at least one control-components system comprises at least one control component adapted to send at least one signal in the presence of liquid; and wherein such at least one signal is adapted to be sent to at least one such electrical component of such at least one electrical-components box; and such at least one electrical-components box is adapted to generate at least one alarm upon receiving such at least one signal). Preferably, float switch 511 generally matches the specification of single level float model LS-12-110 as produced by Innovative Components, U.S.A. Preferably, CVM remote unit 500b is programmable to coordinate an evacuation of the collected fluids within LSC 604 by returning the material to product container 506 via STP 502. Preferably, the body of LSC 604 assembled using standard pipe fittings, as shown. The above described arrangements at least herein embody control-components means for providing at least two kinds of control-components to assist monitoring of the at least one interstitial space and at least herein embodying wherein at least one kind of such at least two kinds of control-components comprises gas-pressure-control components means for assisting control of gas pressure in the at least one interstitial space.

From LSC 604, vacuum transfer line 534 preferably routes to an interstitial vacuum port (hereinafter referred to as IVP 606), as shown. Preferably, IVP 606 is upstream of LSC 604 and taps directly into or extends into secondary containment space 512 at the low (liquid collecting) point 608. Preferably, IVP 606 is located at a modified interstitial port cap, preferably interstitial monitoring cap 655, at interstitial riser 593, as shown.

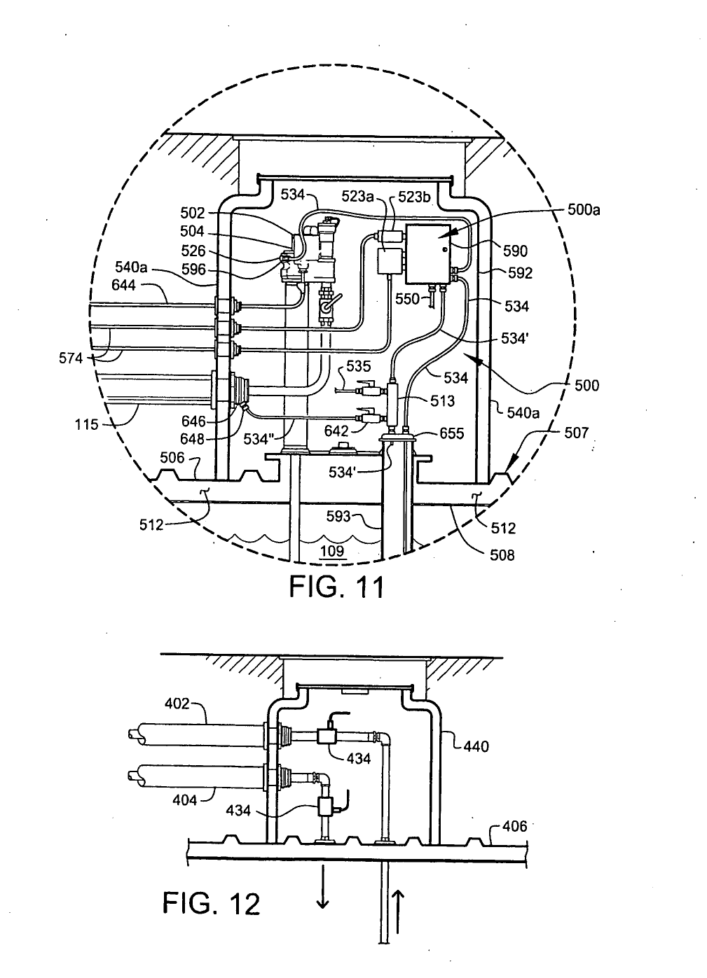

Typically, secondary containment space 512 fully encapsulates primary containment boundary 508, as shown. Preferably, interstitial monitor port (hereinafter referred to as IMP 610) is coupled with secondary containment space 512 by means of the vacuum transfer line 534′ returning from secondary containment space 512, as shown. Preferably, vacuum transfer line 534′ taps directly into secondary containment space 512 at a high point 612 within the tank or monitored product line, as shown. Preferably, high point 612 is similarly located at a modified interstitial port cap, preferably interstitial monitoring cap 655, at interstitial riser 593, as shown. Because secondary containment space 512 typically comprises a continuous envelope about primary containment boundary 508, IMP 610 and IVP 606 are in direct fluid communication, as shown. Preferably, vacuum transfer line 534′, extends from IMP 610 to a differential pressure switch (hereinafter referred to as DPS 615), as shown. Preferably, DPS 615 comprises a unit generally matching the specification of explosion-proof differential pressure switch model H3B-2SL as produced by Dwyer Instruments, Inc. U.S.A. Preferably, DPS 615 is positioned upstream of IMP 610 and is preferably adapted to respond to changes in vacuum level within secondary containment space 512, as shown. Preferably, DPS 615 is located within CVM sump unit enclosure 590, as shown. Preferably, DPS 615 is electrically coupled to CVM remote unit 500b, as shown. Preferably, both DPS 615 and LSC 604 each comprise a separate/dedicated electrical conduit pathway within CVM sump unit enclosure 590 (as best shown in FIG. 10). Preferably, the dedicated conduit serving DPS 615 contains at least one 24 VDC resistance heater 611 adapted to maintain operating temperatures within CVM remote unit 500b during cold season use. Preferably, electrical conductors for both DPS 615 and LSC 604 are routed to CVM remote unit 500b within a single conduit (connecting conduit 574) after passing through J-box 523a, located external to CVM sump unit enclosure 590, as best illustrated in FIG. 11. Preferably, T-fitting 581 passes through CVM sump unit enclosure 590 to join with connecting conduit 574, as shown.

In installations within a single wall containment sump, CVM sump unit 500a is located within a gas-tight vacuum monitored environment. When CVM sump unit 500a is installed within a low-pressure monitored environment, at least one atmospheric gas-pressure conduit 550 is provided to permit the proper operation of DPS 615, as shown. Preferably, atmospheric gas-pressure conduit 550 extends from within the gas-tight vacuum monitored sump to an exterior point permitting atmospheric communication with the neutral “reference” pressure of the surrounding environment. Preferably, neutral gas-pressure conduit 550 extends from the ⅛ NPT high-pressure connection 552 located at the base of DPS 615, to a point external to the gas-tight sump.

Preferably, CVM sump unit 500a comprises a pressure relief arrangement adapted to protect product storage and delivery system 501 from conditions of internal over-pressure and over-vacuum within secondary containment space 512 (as best illustrated in FIG. 9). Preferably, pressure check valve (hereinafter referred to as PCV 616) is positioned upstream of IMP 610 and is preferably adapted to release excess pressure generated within secondary containment space 512 at about 1-2 PSI. Preferably, IMP PCV 616 (at least herein embodying wherein such at least one gas-pressure-control component comprises at least one tank-safety pressure limiter connected with such at least one interstitial space) is located within CVM sump unit enclosure 590, as shown. Preferably, a branch-fitting, positioned in-line with vacuum transfer line 534 between IMP 610 and DPS 615, couples PCV 616 to vacuum transfer line 534, as shown. PCV 616 preferably comprises a one-way pressure-actuated valve in combination with fluid transfer line 618 exhausting vapor released from secondary containment space 512 back to STP head 504, as shown. Preferably, PCV 616 is coupled to STP head 504 using a ¼″ diameter copper tube, as shown.

Preferably, vacuum check valve (hereinafter referred to as VCV 620) is also positioned upstream of IMP 610 and preferably relieves any excess vacuum generated within the interstitial space at about 5 PSI. Preferably, VCV 620 (at least herein embodying wherein such at least one gas-pressure-control component comprises at least one tank-safety pressure limiter connected with such at least one interstitial space) is located within CVM sump unit enclosure 590, as shown. VCV 620 preferably comprises a one-way pressure-actuated valve operating in combination with fluid transfer line 618 by drawing atmosphere from STP head 504, as shown. Under appropriate circumstances, both VCV 620 and PCV 616 may be arranged in a manifold configuration to permit the single atmospheric fluid connection to STP head 504, as shown. Preferably, both VCV 620 and PCV 616 each comprise differential relief valves (¼″ npt male both ends) generally matching model 4M-CO4L-(1or5)-SS as produced by Parker Instrumentation, U.S.A.

Preferably, CVM sump unit 500a comprises at least one test valve 529 openable to admit atmospheric pressure to the system for testing, as shown. Test valve 529 preferably permits the creation of an “engineered leak”, within the interstitial gas-pressure circuit, to assist in confirming system performance. Upon reading this specification, those of ordinary skill in the art will understand that, under appropriate circumstances, considering such issues as user preference, advances in technology, intended applications, etc, the use of other CVM sump unit 500a components, such as internal J-boxes, bulkheads, isolation valves, gauges, indicators, hydrocarbon sensors, etc., may suffice.

FIG. 11 is the detailed sectional view 11 of FIG. 8 further illustrating a preferred installation of CVM sump unit 500a within a typical product storage tank environment. Preferably, CVM sump unit enclosure 590 of CVM sump unit 500a is securely mounted within containment sump 540a, as shown. Preferably, CVM sump unit enclosure 590 is mounted to the upper interior wall 592 of containment sump 540a, as shown. Preferably, CVM sump unit enclosure 590 is mounted to the upper interior wall 592 of containment sump 540a, about 6″ above the lowest sump wall penetration, as shown. Upon reading this specification those of ordinary skill in the art will understand that under appropriate circumstances, considering such issues as user preference, advances in technology, intended storage tank application, etc, other system mounting locations, such as within an adjacent vault, nearby structure, or integrally mounted within other portions of the sump, etc., may suffice. Under appropriate circumstances, the supplier/manufacture of CVM system 500 may preferably supply site-specific system mounting hardware to assist the installer in adapting CVM system 500 to a specific product storage and delivery system 501. Depending on the type of product storage and delivery system to which CVM system 500 is adapted, an arrangement of accessory hardware may comprise tank and/or line fittings, boots and tubing connections. Upon reading this specification, those of ordinary skill in the art will understand that, under appropriate circumstances, considering such issues as user preference, local jurisdictional requirements, specific tank configurations, etc, use of other miscellaneous accessories, such as electrical couplings, seals, mounting brackets, etc., may suffice. Furthermore, CVM system 500 may under appropriate circumstances, comprise components not related to secondary containment monitoring, such as, for example, site security/monitoring components.

Further illustrated in FIG. 11 is the preferred gas-pressure connection between vacuum port 526 at STP head 504 and CVM sump unit 500a described in FIG. 9. Also illustrated is a representative arrangement of vacuum transfer lines originating from CVM sump unit 500a. T-fittings or pneumatic manifolds 513 are preferably used to permit branching of vacuum transfer lines 534 and 534′, within containment sump 540a, as shown. Preferably, pneumatic manifolds 513-are commercially available units supplied by Pneumadyne Inc., U.S.A. (pneumadyne.com). In the example of FIG. 11, a branch vacuum transfer line 534″ is preferably connected to a lower portion of secondary containment space 512 of double contained piping 115, as shown. Preferably, vacuum transfer line 534″ is preferably connected to the lower portion of secondary containment space 512 at bottom connection 648, as shown. The preferred positioning of bottom connection 648 assists CVM sump unit 500a in the removal and collection of liquids collected within secondary containment space 512. The above-described arrangement illustrates a preferred “combined interstitial space” installation of CVM sump unit 500a adapted to monitor secondary containment spaces 512 both of tanks and double contained piping 115 (at least herein embodying wherein such tank interstitial space means and such piping interstitial space means in fluid communication together comprise combined interstitial space means for secondary containment of such environmentally-hazardous petroleum products).

Isolation valves 642 are preferably used to permit secondary containment space 512 of double contained piping 115 to be shut-off from the remainder of the system during diagnostic testing or service. Preferably, CVM system 500 is adaptable to monitor tank and line secondary containment space 512 of product storage and delivery system 501 separately or together depending on site-specific options. CVM system 500 is preferably adaptable to include optional manual or electric isolation valves 642, installable to segregate tank and line secondary containment space 512 thereby assisting the technician locating a detected leak. Preferably pneumatic manifolds 513 is adapted to permit additional vacuum transfer lines, such as vacuum transfer line 535, to be extended to other secondary containment spaces 512, as required.

When properly installed, an alarm mode will preferably shut down operation of STP 502. Preferably, isolation valves 642 comprise brass one-piece ball valves generally matching model B-43F4 by Swagelok, U.S.A. (www.swagelok). Upon reading the teachings of this specification, those with ordinary skill in the art will now understand that, under appropriate circumstances, considering issues such as, tank configurations, product delivery systems, etc., other secondary containment space monitoring arrangements may suffice, such as, for example, the monitoring of remote containment sumps, other product lines, vapor return line, etc.

Preferably, CVM sump unit 500a and CVM remote unit 500b (remotely located from containment sump 540a) are electrically coupled, by means of connecting conduits 574, to form the operational CVM system 500, as shown. Preferably, connecting conduits 574 comprises a high voltage electrical conductors and low voltage communication conductor are routed in separate conduits, as shown. Conduits 574 preferably comprise J-boxes 523, at appropriate intervals, to facilitate installation of conductors and as required by prevailing codes. Preferably, J-boxes 523 located within the containment sumps comprise units having an explosion-proof certification.

FIG. 12 is a partial cross-sectional view, through an underground containment sump, illustrating the use of an alternate vacuum-generating device according to a preferred embodiment of the present invention. In some product handling arrangements, it is impractical or undesirable to use the submersible turbine pump as the vacuum-generating source for the CVM system. For example, it is common in multi-tank systems to install a single submersible turbine pump at the primary storage tank only. A secondary storage container/tank within a fuel handling system typically comprises only a product vacuum delivery line 402 and product pressure return line 404, as shown. Isolated vacuum monitoring systems, such as those located at a secondary storage container/tank necessarily require an alternate source of vacuum gas pressure. FIG. 12 illustrates a typical arrangement of product piping within containment sump 440 of secondary product container 406. Preferably, containment sump 440 houses both product vacuum delivery line 402 and product pressure return line 404, as shown.

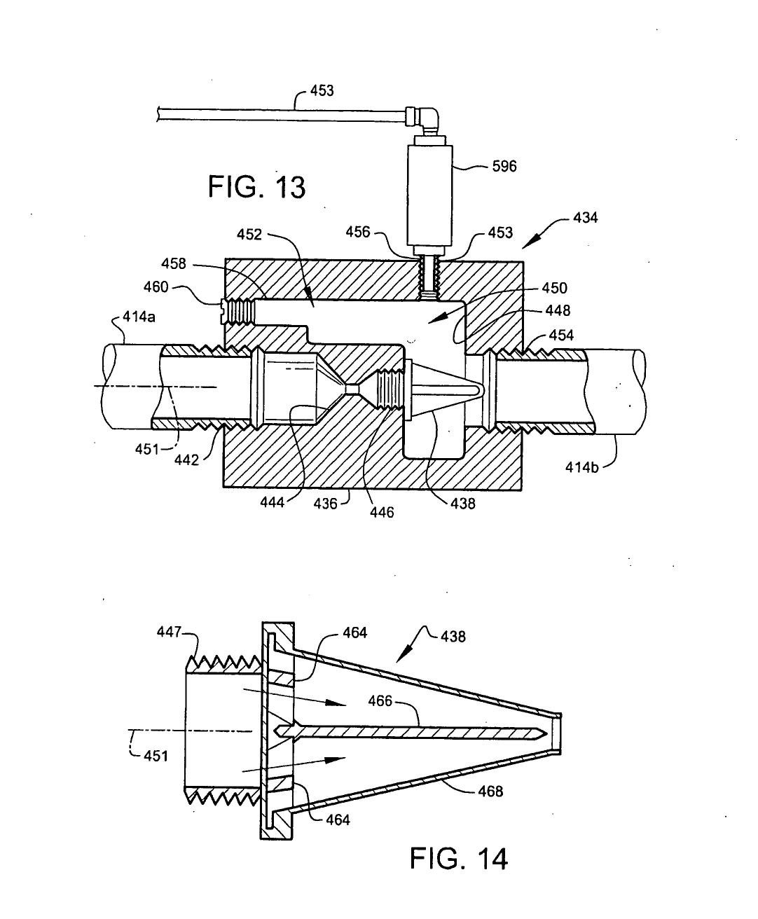

Preferably, both CVM system 100 and CVM system 500 are adapted to operate using vacuum generator 434, as shown. Further details concerning structures/functions of vacuum generator 434 (used therein as a vapor recovery detector) are described in U.S. Pat. No. 6,044,873 issued to one of the current applicants, Zane A. Miller, the contents of which patent are herein included by reference as though fully herein set forth. Preferably, vacuum generator 434 is installed within at least one of the product transfer lines of the product handling system, as shown. Preferably, vacuum generator 434 produces vacuum by utilizing the fluid flow of liquid product moving through the product transfer line, as shown. Vacuum generator 434 preferably utilizes an internal “venturi” arrangement as described in FIG. 13 below. Preferably, vacuum generator 434 is adaptable to operate in either, the product vacuum delivery line 402, or product pressure return line 404, as shown. Vacuum generator 434 is preferably adaptable to operate within any accessible piping having at least a periodic liquid flow. Upon reading the teachings of this specification, those with ordinary skill in the art will now understand that, under appropriate circumstances, considering issues such as, site configuration, operational requirements, etc., other placement arrangements may suffice, such as, for example, the in-line placement of a vacuum generator between the line test port of a submersible turbine pump and the tank test port of a product storage tank.

FIG. 13 is a cross-sectional view of vacuum generator 434 according to the preferred embodiment of FIG. 12. Vacuum generator 434 preferably comprises main body 436 and vacuum generating nozzle 438, as shown (at least herein embodying wherein such at least one gas pressure setter comprises at least one fluid flow system adapted to provide, essentially by Bernoulli effect, such at least one combined level of gas pressure). Preferably, main body 436 comprises fluid inlet port 442 formed in the upper portion of the body. Inlet 442 is preferably a generally cylindrical bore that allows access to the interior of main body 436, and is preferably threaded to allow the coupling of main body 436 to a moving fluid source, preferably product transfer line 414a, (see product vacuum delivery line 402 or product pressure return line 404 of FIG. 12). Preferably, the passageway or bore of inlet 442 narrows to throat 444 that is situated in the middle portion of main body 436. Preferably, throat 444 is a smaller bore that allows communication between inlet 442 and nozzle port 446. Port 446 is preferably a cylindrical bore that is smaller than inlet 442 and larger than throat 444, as shown. Preferably, the end portion of port 446 is threaded to permit receiving of nozzle 438, as is more fully described below. Preferably, port 446 opens to vacuum chamber 448 located within body 436 and which comprises first section 450 and second section 452, as shown.

Preferably, first section 450 and second section 452 are generally orthogonal to one another, as shown. Preferably, first section 450 and second section 452 are in fluid communication with one another, as shown. First section 450 preferably extends laterally away from second section 452 and beyond nozzle port 446 in one direction and extends laterally to second section 452 in the other direction, as shown. Preferably, first section 450 transitions to port 446 and has a fluid and vapor outlet port 454 coupled to its distal edge, as shown. Preferably, port 454 is adapted to permit fluid communication between inlet 442, vacuum chamber 448 and a vacuum supply line, as is more fully described below. Preferably, port 454 comprises a cylindrical bore that is threaded to allow body 436 to be coupled to product transfer line 414b (see product vacuum delivery line 402 or product pressure return line 404 of FIG. 11). Preferably, port 454 extends from the exterior of body 436 inwardly to vacuum chamber 448. Preferably, inlet 442, port 446 and port 454 are all preferably axially aligned so that they share a common centerline 451, as shown.

Preferably, extending from the exterior of body 436 into section 452 is vacuum supply line 456 that is preferably oriented perpendicularly to ports 442 and 454, as shown. Port 456 is preferably a cylindrical bore and is threaded to receive vacuum supply line 453, as shown. Preferably, section 452 further comprises a second vacuum access channel 458 that extends from section 452 to vacuum access port 460, as shown. Preferably, vacuum access port 460 is a cylindrical threaded bore adjacent inlet 442, as shown. Preferably, vacuum access port 460 is sealed however; under appropriate circumstances, vacuum access port 460 may be used to permit placement of additional system sensors. Preferably, vacuum supply line 453 is joined with siphon check valve (SCV 596) to prevent liquid product from entering the CVM monitor system. Preferably, vacuum supply line 453 is routed to the vacuum connection of CVM system 100 and/or CVM system 500.

FIG. 14 is a cross-sectional view through nozzle 438 according to the preferred embodiment of FIG. 12. Referring now to FIG. 14 with continued reference to FIG. 13, nozzle 438 comprises a threaded end 447, which is threadable to port 446, as shown. Preferably, end 462 comprises an open interior that permits passage of fluid, and preferably comprises a number of angled fins 464, as shown. Preferably, three such fins 464 are provided and are equally spaced about the perimeter of nozzle 438, as shown. Preferably, fins 464 are angled radially inwardly and are curved to impart a swirling motion to the flowing fluid. Nozzle 438 is further preferably equipped with a cylindrical center rod 466 suspended within nozzle 438, extending down centerline 451, as shown. Preferably, surrounding rod 466 is a conical tip 468. Preferably, tip 468 is shaped as a truncated cone and has an opening at its lower end to allow fluid to exit. Preferably, rod 466 terminates just above the opening in tip 468, as shown. Preferably, tip 468 is dimensioned such that a lower end extends slightly into port 454 when nozzle 438 is threaded into port 446. Preferably, when fluid is presented to inlet 442, the fluid flows through body 436 by flowing through throat 444, nozzle 438 and port 454. The velocity of fluid exiting nozzle 438 will be increased by the nozzle. This increased velocity lowers the pressure within vacuum chamber 448, thereby creating a vacuum usable by the continuous vacuum monitoring system.

FIG. 15a is a diagram illustrating the preferred internal component arrangements of CVM remote unit 500b according to the preferred embodiment of FIG. 6. The diagram generally illustrates a preferred arrangement of components within a CVM system-typical preferred housing capable of simultaneously controlling/monitoring two CVM sump units 500a. Preferably, Upon reading this specification, those of ordinary skill in the art will understand that, under appropriate circumstances, considering such issues as user preference, advances in technology, etc, other component arrangements, such as the use of additional mounting apparatus, housing sizes, etc., may suffice. Referring now to FIG. 15a, with continued reference to the prior figures, typically CVM remote unit 500b is located at a remote position relative to CVM sump unit 500a. Preferably, CVM remote unit 500b is located within an attended area, such as, for example, within adjacent structure 521 (see FIG. 7). Preferably, CVM remote unit 500b is installed and operated near the main electrical breaker panel 546 (see again FIG. 7). Preferably, CVM remote unit 500b comprises a secure, self-contained, logic and electrical control package. Preferably, CVM remote unit 500b contains a main logic unit, power supply, power cord, audio/visual alarms, relays and other components required to operate and report on the functioning of CVM sump unit 500a. More specifically, CVM remote unit 500b preferably comprises; CVM control enclosure 624 (liquid resistant McMaster-Carr), CVM 25 amp control relays 626, a single CVM logic unit 628, CVM control panel mounting brackets 630, CVM audio alarm 632 (pulsing piezo buzzer model 273-066, Radio Shack, U.S.A., or equal), CVM power supply 634, CVM heater cable 611 (Model 3554K21, McMaster-Carr), CVM display indicators 636, as shown. Additionally, CVM remote unit 500b is preferably supplied with CVM service software and system operation manuals. The above-described parts listing is typical of preferred commercial embodiments of CVM remote unit 500b. Upon reading this specification, those of ordinary skill in the art will understand that, exact part arrangements are generally site specific and may include other site-specific accessory components.

Preferably, CVM 25 amp control relays 626 comprise a solid state DC relay such as model 5Z956 as produced by Dayton, U.S.A. Preferably, control relays 626 comprises a maximum input voltage of 32 VDC, minimum input voltage of 3 VDC, AC minimum output voltage of 24 VAC and a maximum AC output voltage of 280 VAC.

Preferably, CVM logic unit 628 comprises a RS232/RS485 relay I/O interface such as model ADR2205 produced by Ontrack Control Systems Inc. of Sudbury, Ontario, Canada. Preferably, CVM logic unit 628 permits control of up to 8 relay contact outputs, 4 contact or TTL inputs, and one event counter via an RS232 or RS485 link. Preferably, CVM logic unit 628 is adapted to serve as a programmable logic controller adapted to control the operation of system vacuum setting components (at least herein embodying wherein such at least one monitor comprises at least one computer monitor structured and arranged to computer-assistedly monitor gas pressure in such at least one tank interstitial space). As previously disclosed, CVM logic unit 628 is preferably programmable using standard programming languages including Visual Basic, Basic, C, Labview, Testpoint or other high level languages that allow access to a serial port. Preferably, CVM logic unit 628 comprises a series of data acquisition interfaces that are daisy chainable up to ten units. Preferably, CVM logic unit 628 contains at least one RS232 to RS485 converter. Preferably, CVM logic unit 628 comprises a bank of relay output connectors 629, as shown. Preferably, relay output connectors 629 comprise eight numbered relay outputs labeled K0 thru K7. Preferably, relay output connectors 629 are electrically coupled to control relays 626 using insulated conductors of a suitable gauge.

Preferably, CVM power supply 634 is adapted to provide regulated power to CVM logic unit 628. Preferably, CVM power supply 634 is electrically coupled to the power input terminals at CVM logic unit 628 using insulated conductors of a suitable gauge. Preferably, CVM power supply 634 comprises an open-frame 25-watt AC powered DC switching device with a 5VDC, 2 amp output. Preferably, CVM power supply 634 comprises model PD-2503 produced by Mean Well and distributed by Jameco Electronics (jameco.com).

Preferably, dual-row barrier strips 631 are provided to assist in routing electrical conductor as well as to permit convenient removal of components during service. Preferably, an array of indicator lights 633 (as further described in FIG. 18) provides the user with a visual reference to the operational status of the system. Preferably, audible alarm switch 654 is adapted turn on and off only the audible portion of the leak indicating alarm.

Upon reading this specification, those of ordinary skill in the art will understand that, under appropriate circumstances, considering such issues as user preference, advances in regulatory requirements, intended use, etc, the use of remote monitoring communication components within CVM remote unit 500b, such as modems, dialers, wireless communication devices, etc., may suffice. Preferably, CVM remote unit 500b comprises modem 560 (indicated by dash lines) to permit the transmission of system data to a remote site (see FIG. 16).

Preferably, CVM system 500 groups the majority of functioning component of CVM remote unit 500b within CVM STP control enclosure 624, as shown. This preferred and novel arrangement permits CVM remote unit 500b to be substantially factory pre-assembled and pre-tested, thereby increasing installation efficiencies and system reliability.

Power and communication between CVM remote unit 500b, CVM sump units 500a and any site-specific sump components are preferably provided by dedicated conduits 574, as shown. Upon reading this specification, those of ordinary skill in the art will understand that, under appropriate circumstances, considering such as user preference, installation type, etc, other electrical arrangements, such as the use of battery power, quick-connect fittings for sump to remote panel communication connections, etc., may suffice.

Preferably, external communication port 638 is accessible on backside of front panel 640, as shown. Preferably, front panel 640 is lockable to permit authorized only access to CVM remote unit 500b (at least herein embodying wherein such at least one electrical-components box comprises at least one tamper-proof system to limit unauthorized access to such at least one electrical-components system). Preferably, CVM remote unit 500b can be safely placed in at least one easily accessible location while limiting unauthorized access to the internal electrical-components. Preferably, authorized personnel can access external communication port 638 of CVM remote unit 500b by opening the locked and hinged front panel 640, as shown. Preferably, a separate diagnostic CPU 578 (as supplied by a trained CVM system technician), equipped with CVM software, is connectable to external communication port 638 to initiate system reset, calibration and testing.

Preferably, relay components of CVM remote unit 500b are connected in-line with power leads 644 of STP 502, to break coil power (as described in FIG. 6). These power connections may preferably include, subject to specifics of the site, high voltage electrical conductors of an appropriate size. Upon reading this specification, those of ordinary skill in the art will understand that, under appropriate circumstances, considering such issues as user preference, local electrical requirements, intended site application, etc, other power source arrangements, such as the use of 24V DC, 120V AC, 240V AC, 240V AC, or 17.5 mf capacitors, etc., may suffice. Furthermore, upon reading this specification, those of ordinary skill in the art will understand that, under appropriate circumstances, more than one power source or service disconnect may be necessary to properly install CVM system 500.

FIG. 15b is a diagram illustrating the preferred internal component arrangements of another embodiment of CVM remote unit 500b according to the present invention. The diagram generally illustrates a preferred arrangement of components within a CVM system-typical preferred housing capable of controlling/monitoring up to four CVM sump units 500a. For clarity, the embodiment of FIG. 15b will hereinafter be referred to as CVM remote unit 500c. It should be understood that the application and operation of CVM remote unit 500c is fully consistent all aspects of the prior disclosed descriptions for CVM remote unit 500b. Upon reading this specification, those of ordinary skill in the art will understand that, under appropriate circumstances, considering such issues as user preference, advances in technology, etc, other component arrangements, such as the duplication of components, for the purpose of providing expanded remote unit capabilities, may suffice.

Referring now to FIG. 15b, with continued reference to the component specifications of FIG. 15a, typically, CVM remote unit 500c is located at a remote position relative to CVM sump unit 500a. Preferably, CVM remote unit 500c is located within an attended area, such as, for example, within adjacent structure 521 (see FIG. 7). Preferably, CVM remote unit 500c is installed and operated near the main electrical breaker panel 546 (see again FIG. 7). Preferably, CVM remote unit 500c comprises a secure, self-contained, logic and electrical control package; Preferably, CVM remote unit 500c contains a main logic unit, power supply, power cord, audio/visual alarms, relays and other components required to operate and report on the functioning of CVM sump unit 500a. More specifically, CVM remote unit 500c preferably comprises; CVM STP control enclosure 624 (liquid resistant McMaster-Carr), 25 amp control relays 626, a pair of CVM logic units 628, CVM control panel mounting brackets 630, CVM audio alarm 632 (pulsing piezo buzzer model 273-066, Radio Shack, U.S.A., or equal), CVM power supply 634, CVM heater cable 611 (Model 3554K21, McMaster-Carr), CVM display indicators 636, as shown. Additionally, CVM remote unit 500c is preferably supplied with CVM service software and system operation manuals. The above-described parts listing is typical of preferred commercial embodiments of CVM remote unit 500c. Upon reading this specification, those of ordinary skill in the art will understand that, exact part arrangements are generally site specific and may include other site-specific accessory components.

Component specifications of CVM remote unit 500c preferably match those as described for the remote unit of FIG. 15a. Preferably, CVM remote unit 500c essentially comprises the combined components of two FIG. 15a embodiments, within a single housing, as shown. Preferably, two CVM logic units 628 are vertically stacked using threaded standoff hardware, as shown. Preferably, the double arrangement of CVM logic units 628 permits control of up to eight control relays 626, as shown.

Preferably, a single CVM power supply 634 is adapted to provide regulated power to both CVM logic units 628, as shown. Preferably, CVM power supply 634 is electrically coupled to the power input terminals at each CVM logic unit 628 using insulated conductors of a suitable gauge.

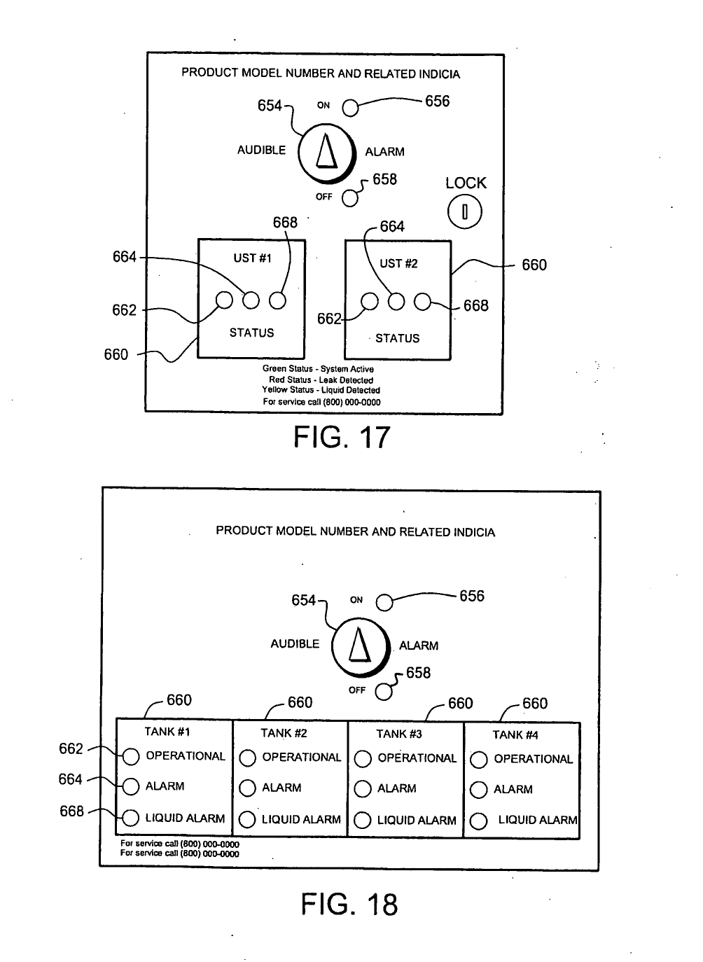

Preferably, dual-row barrier strips 631 are provided to assist in routing electrical conductor as well as to permit convenient removal of components during service. Preferably, an array of indicator lights 633 (as further described in FIG. 17 and FIG. 18) provides the user with a visual reference to the operational status of the system. Preferably, audible alarm switch 654 is adapted turn on and off only the audible portion of the leak indicating alarm.

Upon reading this specification, those of ordinary skill in the art will understand that, under appropriate circumstances, considering such issues as user preference, advances in regulatory requirements, intended use, etc, the use of remote monitoring communication components within CVM remote unit 500c, such as modems, dialers, wireless communication devices, etc., may suffice. Preferably, CVM remote unit 500c comprises modem 560 (indicated by dash lines) to permit the transmission of system data to a remote site (see FIG. 16).

Preferably, CVM system 500 groups the majority of functioning component of CVM remote unit 500c within CVM STP control enclosure 624, as shown. This preferred and novel arrangement permits CVM remote unit 500c to be substantially factory pre-assembled and pre-tested, thereby increasing installation efficiencies and system reliability.

Preferably, first high-voltage conductor grouping 680, exiting CVM control enclosure 624, comprises four pairs of high voltage electrical conductors, originating at control relays 626, as shown. Preferably, first high-voltage conductor grouping 680 is adapted to control the breaking of coil power at one or more STPs 502, as shown. Preferably, second high-voltage conductor grouping 682 comprises the remaining pairs of conductors, originating at control relays 626, as shown. Preferably, second high-voltage conductor grouping 682 are dedicated to the operation of the vacuum control valves (VCV 598) located within the CVM sump units 500a. Preferably, low-voltage conductor grouping 684 extend from logic unit 628 to the communication connections at float switch 511 and DPS 615 within CVM sump units 500a. Preferably, second high-voltage conductor grouping 682 are routed through fuse block 686, as shown. Preferably, ground connections 688 are supplied at control enclosure 624, as shown.

Preferably, external communication port 638 is accessible on backside of front panel 640, as shown. Preferably, front panel 640 is lockable to permit authorized only access to CVM remote unit 500c. Preferably, authorized personnel can access external communication port 638 of CVM remote unit 500c by opening the locked and hinged front panel 640, as shown.

FIG. 16 diagrammatically illustrates CVM system 500, interoperating with remote management system 742, according to a preferred embodiment of the present invention. Preferably, CVM system 500 operates within local site 702 (diagrammatically indicated by dashed lines forming a rectangular-shaped boundary). As in the prior examples, site 702 contains liquid product storage and handling system 101, as shown. Preferably, CVM system 500 is adapted to continuously monitor essentially all underground product handling components of liquid product storage and handling system 101, as previously described.

Preferably, monitoring CVM system 500 is adapted to permit communication with at least one remote monitoring system 742, as shown. In a typical preferred arrangement, remote monitoring system 742 comprises a computer-based data-server acting to log and process data arriving from CVM system 500, as shown. CVM system 500 is preferably adapted to support remote communication using at least one standard network protocol over one or more standardized computer networks. Preferably, CVM system 500 is adapted to support remote communication by operating within at least one public network environment, preferably the Internet 744, as shown. Those skilled in the art, upon reading the teachings of this specification, will appreciate that, under appropriate circumstances, considering issues such as system location, monitoring requirements, etc., other methods of data monitoring, such as site remote data monitoring using automatic dialers, private networks, wireless components adapted to transmit system performance data to a remote monitoring site, etc., may suffice.

FIG. 17 is a front view of a typical arrangement of control panel display 652 according to the preferred embodiment of FIG. 6. Preferably, operation and maintenance of CVM system 500 CVM is straightforward and intuitive. Preferably, all routine operational tasks can be performed at CVM remote unit 500b. Preferably, the operational tasks required to operate CVM system 500 are primarily observational. Preferably, the condition of containment systems monitored by CVM system 500 can be easily observed and interpreted by observing control panel display 652 of CVM remote unit 500b. Preferably, control panel display 652 (at least herein embodying wherein such at least one electrical-components box comprises at least one external-surface element adapted to permit, without providing internal access to such at least one electrical-components system, at least one safety signal to be read) comprises a simple array of red, green and yellow indicator lights, and at least one audible alarm-muting switch, as shown. Preferably, audible alarm switch (AAS 654) is adapted turn on and off only the audible portion of the leak indicating alarm. Preferably, CVM system 500 continues to function while AAS 654 is in the “Off” position. As disclosed previously, CVM system 500 preferably implements pump shutdown and initiates at least one visual alarm on detecting a leak condition.

Preferably, AAS 654 (at least herein embodying wherein such at least one electrical-components box comprises at least one external-surface element adapted to permit, without providing internal access to such at least one electrical-components system, at least one alarm to be disabled) comprises two associated indicator lights, as shown. Preferably, each associated indicator light indicates an operational condition of the audible portion of the leak indicating alarm. Preferably, an illuminated green indicator light 656 signals the audible alarm is turned “On.” Preferably, an illuminated red indicator light 658 signals the audible alarm is turned “Off.”

Preferably, control panel display 652 comprises two UST status fields 660, as shown. Preferably, each UST status field 660 is marked with identifying indicia, such as “UST No. 1”, “UST No. 2”, etc. Preferably, each UST status field 660 comprises one green status light 662, one red status light 664 and one yellow status light 668, as shown. Preferably, an illuminated green status light 662 indicates the associated interstitial monitor is operating properly. If the green status light 662 is not illuminated, that particular interstitial monitor is non-operational. If the system is expected to be operational, a non-illuminated green light 662 indicates a malfunctioning system.

Preferably, when the green status light 662 is illuminated (see above) and the red status light 664 is non-illuminated, it indicates that the monitoring system is working properly and no leak is currently detected. If the red status light 664 is illuminated, the system is in pump shutdown mode. In this condition, the audible alarm will also sound, assuming it is turned “On” (see above). A service visit from an authorize service technician will be required to further evaluate the cause of the alarm. Preferably, in pump shutdown mode, the corresponding STP 502 will not dispense fuel.

Preferably, an illuminated yellow status light 668 indicates that CVM system 500 detected liquid within secondary containment space 512 (LSC 604 has collected a quantity of liquid to trigger the internal float thereby sending and electrical signal to logic unit 628). In this condition, CVM system 500 may preferably initiate a brief STP 502 startup to generating vacuum to permit evacuation of any remaining liquid from secondary containment space 512 (the liquid is preferably returned to the primary containment via STP head 504 vacuum port connection). Under appropriate circumstances, dependent on factors such as, for example, specific regulatory requirements, logic unit 628 can be programmed to immediately shutdown STP 502 on detection of liquid.

Upon reading this specification, those of ordinary skill in the art will understand that, under appropriate circumstances, considering such issues as user preference, advances in technology, intended monitoring site, etc, other panel arrangements, such as a single panel indicating the status of additional UST's may suffice.

FIG. 18 is a front view of another preferred control panel display arrangement according to the preferred embodiment of FIG. 15b. As previously described, CVM remote unit 500c is preferably adapted to monitor a plurality of independent secondary containment spaces/interstices. Upon reading the teachings of this specification, those with ordinary skill in the art will now understand that, under appropriate circumstances, considering issues such as regional jurisdictional requirements, storage/handling provisions, etc., other monitor/display arrangements may suffice, such as, for example, the duplication of internal components to produce a remote unit having expanded monitoring capabilities. Preferably, the CVM remote unit 500c, as illustrated in FIG. 18, provides for the monitoring of four independent secondary containment spaces/interstices. Preferably, control panel display 653 is adapted to display the status condition of four independent secondary containment spaces. Preferably, control panel display 653 comprises an easily comprehensible array of red, green and yellow indicator lights, and at least one audible alarm-muting switch, as shown. Preferably, control panel display 653 comprises four tank (UST) status fields 660, as shown. Preferably, each UST status field 660 is marked with identifying indicia, such as “TANK #1”, “TANK #2”, etc. Preferably, each UST status field 660 comprises one green status light 662, one red status light 664 and one yellow status light 668, as shown. Preferably, both visual display and unit operation of control panel display 653 are as generally described for control panel display 652 of FIG. 17 above.

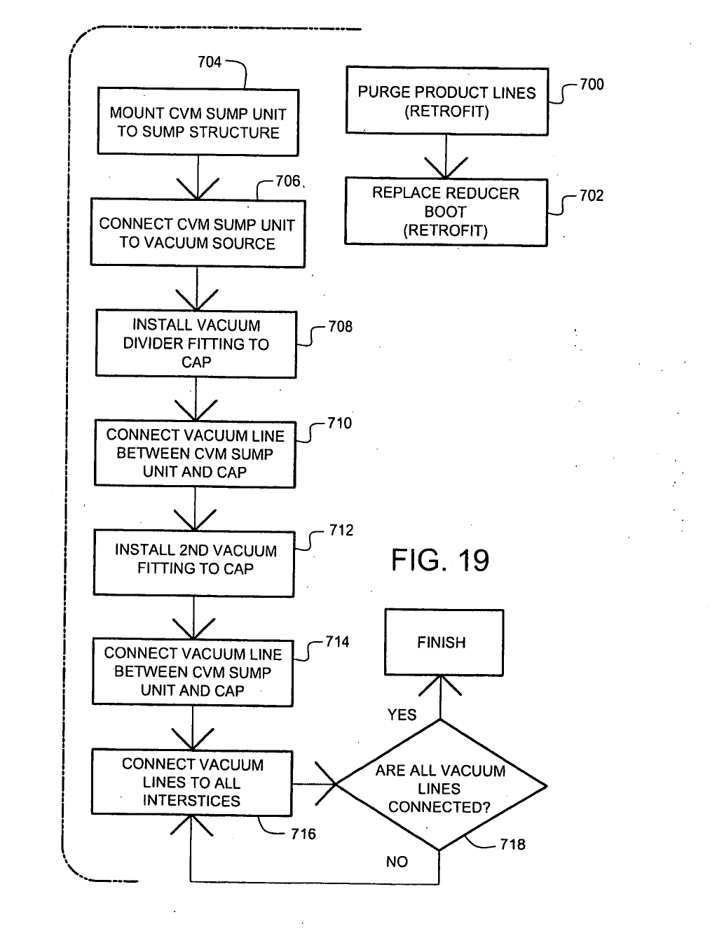

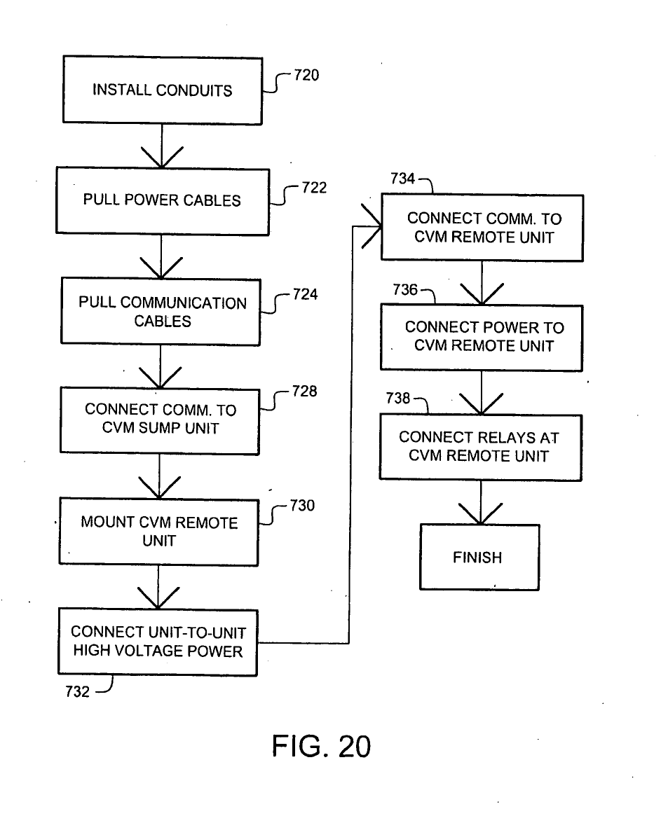

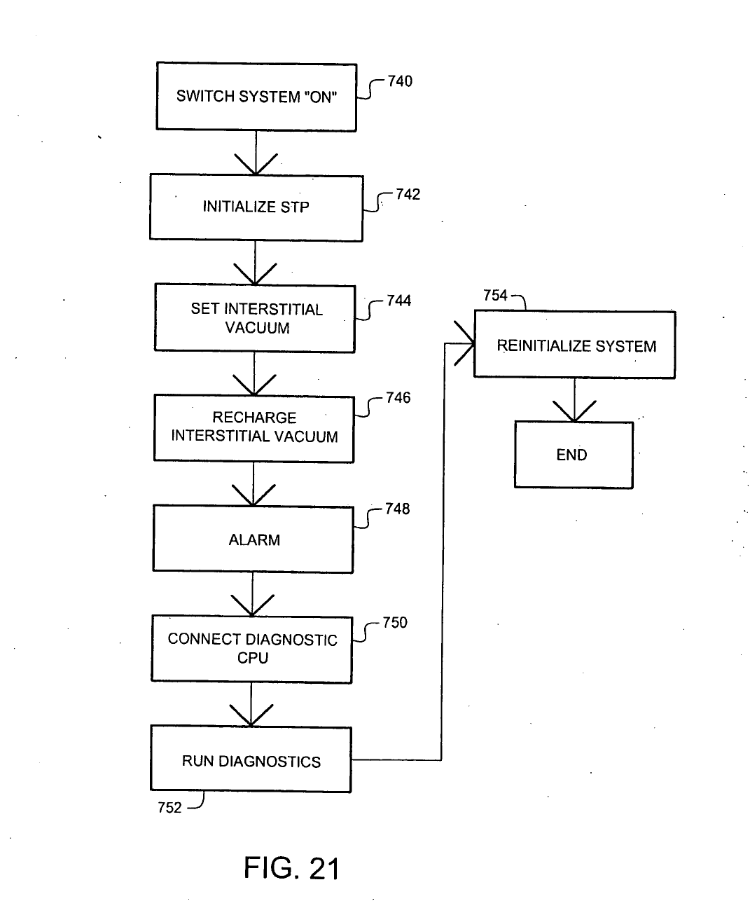

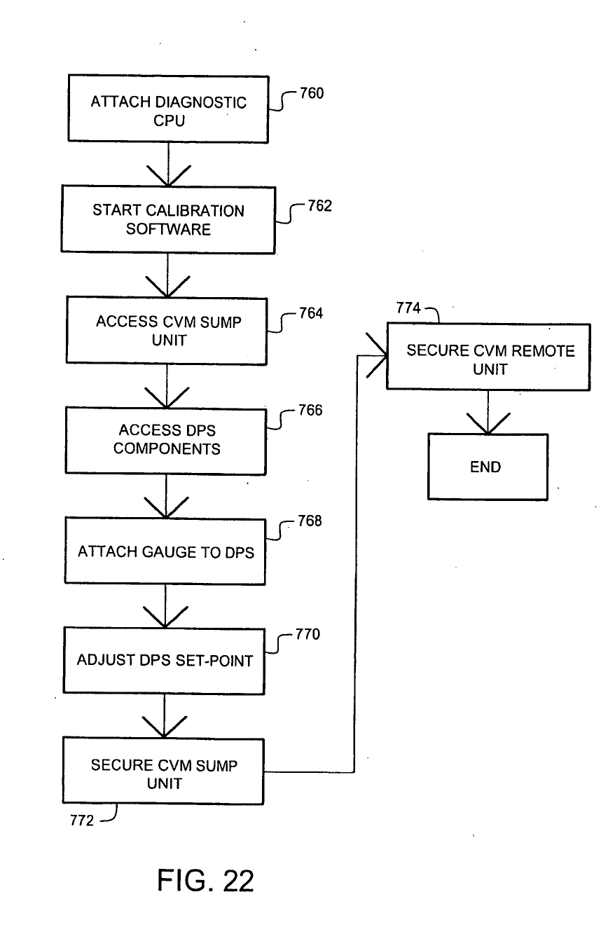

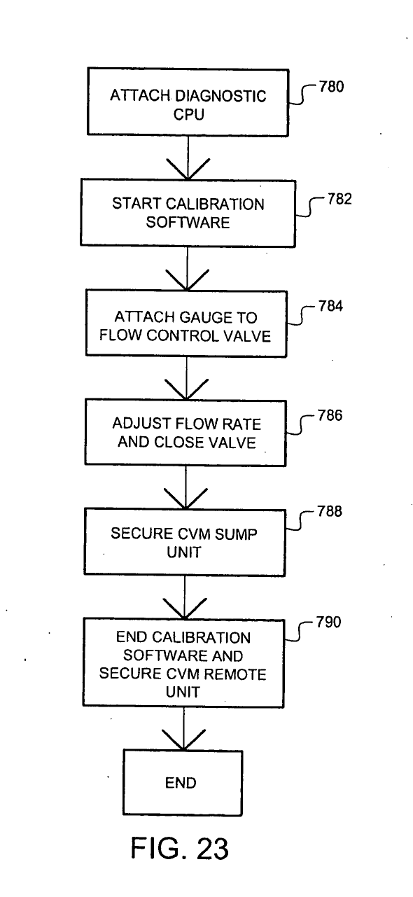

FIG. 19, FIG. 20, FIG. 21, FIG. 22 and FIG. 23 illustrate typical installation, calibration and start-up procedures for CVM sump unit 500a. Those skilled in the art will appreciate that, under appropriate circumstances, depending on the site and/or preferred system configuration, other site-specific steps, such as necessary physical modifications to a specific installation site, are within the scope of the present invention. In the following steps, continued reference is made the prior figures and component references of the prior embodiments.

FIG. 19 generally illustrates the installation steps for CVM sump unit 500a, representative of a typical site installation, according to preferred methods of the present invention. Initial steps in the installation of CVM system 500 varies between new installations and existing installations that have previously been in operation. In previously operated site, an installer will preferably flush the product lines of residual product, prior to installation of the monitoring system as depicted in step 700. Flushing ensures both the safety of the installer and the site during system installation. In general, line flushing is not required prior to installing CVM system 500 in a new product handling system.

Methods of flushing the product lines of product are well known to those skilled in the art and with therefore be described in general terms only. Preferably, the installer of a retrofit monitoring system flushes the product lines by applying nitrogen gas to an impact valve test port at a dispenser impact valve located furthest from STP 502. The installer preferably opens a vapor adapter coupling at a Phase I vapor riser (typically located in a fill sump) to prevent overpressure within the tank during line purging. Preferably, installer applies about 15-PSI (maximum) nitrogen at impact valve connection until the product line is empty and drained completely of product.

Additionally, in retrofit installations of CVM system 500, the installer preferably, replaces the existing primary/secondary line reducer boots serving the braided steel flexible product lines within the containment sump. Preferably, new CVM system 500 compatible primary/secondary line reducer boots 646 with leak prevention and leak detection ports are installed in their place as depicted in step 702 (see also FIG. 11). Upon reading this specification, those of ordinary skill in the art will understand that, under appropriate circumstances, considering such issues as user preference, system configuration, etc, other system preparations, such as, replacing/modifying additional product line fittings, may suffice. Preferably, the installer connects leak prevent vacuum line to CVM sump unit 500a and to the bottom connection 648 of primary/secondary line reducer boot 646 (see especially FIG. 1).

The following preferred steps, for the installation of CVM sump unit 500a, are generally applicable to both new and existing product storage and delivery systems 501. In an initial installation step, CVM sump unit 500a is securely mounted, within the containment sump, about 6″ above the lowest sump penetration point as depicted in step 704. Preferably, as depicted in step 706, vacuum transfer line 534 is connected between the STP siphon check valve (SCV 596) and CVM sump unit 500a. As depicted in step 708, a “T” fitting (or pneumatic manifold 513, as shown) with isolation valve 642 (at least herein embodying installing at least one selectable isolator to permit selective monitoring of at least one interstitial space portion from at least one other interstitial space portion of such at least one interstitial space) is preferably fitted to interstitial monitoring cap 655 (at least herein embodying at least one sealed upper cap adapted to provide access for such at least one gas pressure line to such at least one handling container interstitial space). Step 710 depicts the preferred installation of vacuum transfer line 534′ between CVM sump unit 500a and pneumatic manifold 513 of interstitial monitoring cap 655. Preferably, as depicted in step 712, IVP 606 is fitted to interstitial monitoring cap 655. Step 714 depicts the preferred installation of vacuum transfer line 534 between CVM sump unit 500a and IVP 606 of interstitial monitoring cap 655. Preferably, vacuum transfer line 534′ is connected, by means of pneumatic manifold 513, to other monitorable interstice, including the interstitial spaces of double contained piping 115 as depicted in step 716 (at least herein embodying installing at least one vacuum branch line between such at least one vacuum line entry connection and such at least one other such at least one interstitial space). As previously noted, the interstitial vacuum port connections of vacuum transfer line 534′ at double contained piping 115 are preferably located at the lowest point of the pipe. Preferably, vacuum transfer line 534′ and related fittings are preferably arranged to avoid the creation of areas of liquid entrapment. Furthermore, step 716 depicts the subsequent connection of vacuum transfer line 534, through pneumatic manifold 513, to all other monitorable interstice, including the interstices of double contained piping 115. Preferably, the vacuum line connection process of step 716 is repeated in step 718 until all piping interstices are connected to an appropriate vacuum transfer line.

FIG. 20 generally illustrates representative preferred installation steps of a typical site installation of power and communication connections between CVM sump unit 500a and CVM remote unit 500b. Initial step 720 depicts the installation of an approved trench excavation from adjacent structure 521 (C-store, garage, kiosk, etc.) to the closest adjacent containment sump 540a for both power conduit and communications conduits 574. Step 722 depicts the installation of power conductors for all product storage containers (for example, UST 507). Step 724 depicts the installation of communications conductors for all product storage containers (for example, UST 507). Step 728 depicts the connection of communications conductors to CVM sump unit 500a.

Step 730 depicts the mounting of CVM remote unit 500b onto CVM control panel mounting brackets 630 in adjacent structure 521 (preferably close to main breaker panel 546 and STP 502 relays). Step 732 depicts the connection of high-voltage power conductors from CVM sump unit 500a to CVM remote unit 500b. Step 734 depicts the connection of low-voltage communication conductors from CVM sump unit 500a to CVM remote unit 500b. Step 736 depicts connection of 110 VAC power supply (or an appropriate voltage) to CVM remote unit 500b. Step 748 depicts the connection of positive shutdown relays to CVM remote unit 500b.

FIG. 21 generally illustrates preferred initialization steps for CVM system 500. Step 740 depicts an authorized technician switching CVM system 500 “on” for initial start-up. It should be noted that CVM system 500 is preferably shipped with a vacuum set point of about 20″ water column and a flow set point is preferably calibrated “on-site” per the component calibration procedures disclosed herein. As previously disclosed, the system vacuum set point can be selectively adjusted to meet site-specific conditions or needs. Step 742 depicts that CVM system 500 will initialize STP 502. Preferably, CVM system. 500 will run through an initial interstitial vacuum charge to reach a vacuum set point as depicted in step 744. If all secondary monitored components of product storage and delivery system 501 are within specification and are gas-tight, CVM system 500 will maintain set point vacuum the set point of step 744. Preferably, if vacuum decreases in the monitored components of product storage and delivery system 501, CVM system 500 will recharge secondary containment space 512 (preferably, the system is selectively programmable to repeat the recharge between once and about twenty four times), back to the set point vacuum, as indicated in step 746. Preferably, if the vacuum continues to decrease within in a preset time period (selectively programmable up to about sixty minutes), CVM system 500 will consider this a leaking condition and enter alarm mode as depicted in step 748. Preferably, prior to re-initialization, the technician preferably attaches diagnostic CPU 578 to external communication port 638 of CVM remote unit 500b as depicted in step 750. Step 752 depicts the technician running diagnostic software to determine cause of failure. Preferably, after detected leak is located and repaired, CVM system 500 is reinitialized as indicated by step 754.

FIG. 22 generally illustrates preferred calibration steps for the differential pressure switch (DPS 615), located within CVM sump unit 500a, according to a preferred method of the present invention. Preferably, CVM system 500 is designed as a relatively simple and robust system. Preferably, the only components within CVM system 500 that require periodic calibration are the DPS 615 and the vacuum flow control valve. Preferably, both DPS 615 and the vacuum flow control valve are checked, and calibrated as necessary.

Under current regulatory requirements, CVM system 500 is required to be certified once per calendar year. Typically, certification of CVM system 500 must be conducted by authorized personnel only. Preferably, DPS 615 settings are factory set prior to site delivery. Preferably, DPS 615 is checked, and calibrated as necessary, during installation and service visits. Preferably, qualified service personnel can verify settings and make adjustments in the field preferably using a calibrated differential pressure gauge in conjunction with CVM system 500 software.

Preferably, to calibrate DPS 615, an authorized technician unlocks and opens CVM remote unit 500b and attaches diagnostic CPU 578 to external communication port 638 of CVM remote unit 500b as depicted in step 760. Preferably, the authorized technician initiates the CVM software application using diagnostic CPU 578 and selects “Calibration Mode” in the CVM software application as depicted in step 762. Preferably, the authorized technician proceeds to sump mounted CVM sump unit 500a, unlocks, and opens the CVM sump unit 500a as depicted in step 764. Preferably, the authorized technician accesses the functional components of DPS 615 by removing the housing lid of DPS 615 as depicted in step 766. Preferably, the authorized technician removes the exposed calibration port cap of DPS 615 and attaches an external gauge to the test valve output as depicted in step 768. Preferably, the authorized technician rotates the test valve to the open position and uses an appropriate tool to adjust the vacuum threshold set point as depicted in step 770. Preferably, in calibration mode, the system will continue to recharge vacuum without going into alarm. Preferably, the authorized technician continues adjusting the set point until system stabilizes at the desired vacuum gas pressure. Preferably, the authorized technician rotates the test valve to the closed position, detaches the external gauge from the test valve output, secures the calibration port cap and housing lid of DPS 615 and secures the CVM sump enclosure as depicted in step 772. Preferably, the authorized technician proceeds to CVM remote unit 500b, selects “Operation Mode” in the CVM software, exits the software application, and secures the CVM remote unit 500b as depicted in step 774.

FIG. 22 generally illustrates preferred calibration steps for the flow control valve (FCV 602), located within CVM sump unit 500a, according to a preferred method of the present invention. Preferably, flow control valve (FCV 602) is used to calibrate an allowable vapor leak rate for CVM system 500. Currently, the allowable vapor leak rate is based on the European Test Protocol adopted by the National Work Group on Leak Detection Evaluations. Currently, the allowable vapor leak rate is about 85 L/hr. Preferably, CVM system 500 is adapted to permit qualified service personnel to make field adjustments using a calibrated flow meter and the CVM software of the present invention. Preferably, CVM system 500 is adapted to permit a range of operational parameters, tailored to the specific jurisdictional requirements under-which the system operates.

Preferred steps for field calibration of FCV 602 are generally disclosed in the following steps of FIG. 23. Preferably, the authorized technician unlocks and opens CVM remote unit 500b and attaches diagnostic CPU 578 to external communication port 638 of CVM remote unit 500b as depicted in step 780. Preferably, the authorized technician starts the CVM software application and selects “Calibration Mode” within the CVM software application as depicted in step 782. Preferably, the authorized technician proceeds to sump mounted CVM sump unit 500a and attaches a flow meter to the output of flow control valve (FCV 602) as depicted in step 784. Preferably, the authorized technician rotates FCV 602 to the open position and adjusts the flow through the external meter to a selected rate. Preferably, while CVM system 500 resides in calibration mode, CVM system 500 will continue to recharge vacuum without going into alarm. Preferably, the authorized technician adjusts FCV 602 until each vacuum recharge takes 2.5 minutes and then adjusts FCV 602 to the closed position as depicted in step 786. Preferably, the authorized technician detaches the external meter from the output of FCV 602 and secures CVM sump unit 500a as depicted in step 788. Preferably, the authorized technician proceeds to CVM remote unit 500b, selects “Operation Mode” within the CVM software, exits the application and secures CVM remote unit 500b as depicted in step 790. Upon reading this specification, those of ordinary skill in the art will understand that vacuum flow controller calibration is generally site specific and is dependent on a number of factors including local code requirements, system configurations, requirements, etc.

Thus, in accordance with preferred embodiments of the present invention, there is provided, relating to vacuum monitoring of secondary containment systems relating to environmentally-hazardous petroleum products, a method of installation of at least one interstitial-space monitoring system comprising, in combination, the steps of: providing at least one first-components system structured and arranged to have at least one sensory coupling with such at least one interstitial space and comprising at least one gas pressure setter adapted to set at least one gas pressure in such at least one interstitial space and at least one second-components system structured and arranged to have at least one signal coupling with such at least one first-components system; wherein such at least one first-components system comprises a set of sump-access-locatable elements; and wherein said at least one second-components system comprises a set of operator-access-locatable elements; securely mounting such at least one first-components system to at least one sump structure; installing at least one vacuum line entry connection between such at least one first-components system and at least one vacuum source; and installing at least one vacuum line entry connection between such at least one first-components system and such at least one interstitial space. Also, the method may preferably include the step of installing at least one vacuum line exit connection between such at least one first-components system and such at least one interstitial space. And it may also preferably include the steps of installing at least one selectable isolator to permit selective monitoring of at least one interstitial space portion from at least one other interstitial space portion of such at least one interstitial space; and installing at least one vacuum branch line between such at least one vacuum line entry connection and such at least one other such at least one interstitial space; and, further, the step of installing at least one vacuum branch line between such at least one vacuum line exit connection and such at least one other such at least one interstitial space; and, further, steps of installing at least one system compatible product line fitting; connecting at least one vacuum line connection to such at least one system compatible product line fitting; and vacuum-purging at least one product line of residual product.

Thus, in accordance with this invention, there is also provided, relating to vacuum monitoring of secondary containment systems relating to environmentally-hazardous petroleum products, a method of operation of at least one interstitial-space monitoring system comprising, in combination, the steps of initializing at least one product delivery pump to set at least one interstitial vacuum pressure within at least one interstitial vacuum pressure range; essentially continuously monitoring whether such at least one interstitial vacuum pressure is within such at least one interstitial vacuum pressure range; on detection of such at least one interstitial vacuum pressure outside such at least one interstitial vacuum range, resetting such at least one interstitial vacuum pressure to within such at least one interstitial vacuum pressure range; and generating at least one alarm if such at least one interstitial vacuum pressure falls outside such at least one interstitial vacuum pressure range within at least one first preselected time span. And this method also preferably includes the step of, upon such at least one alarm, disabling such at least one product delivery pump; and, further, preferably includes the step of generating at least one alarm if, on detection of such at least one interstitial vacuum pressure outside such at least one interstitial vacuum range, such resetting can not be accomplished within at least one second preselected time span; and, further, the steps of diagnosing the cause of such at least one alarm by at least one trained technician; and reinitializing operation.

It is particularly noted that, in the preferred method of operation of the instant invention, considering theoretical aspects, usable devices, safety considerations, and applicants' use experiences, etc., a preferred range of interstitial vacuum pressure (using the scale of inches of water for the vacuum level) is from about one inch of water to about 120 inches of water, more preferably from about one inch of water to about 20 inches of water, and most preferably from about fifteen inches of water to about 20 inches of water.

And thus, in accordance with preferred embodiments hereof, there is provided, relating to vacuum monitoring of secondary containment systems relating to environmentally-hazardous petroleum products, a method of calibration of at least one interstitial-space monitoring system comprising, in combination, the steps of initiating at least one system calibration routine within at least one computer monitor; and calibrating at least one pressure setting of at least one differential pressure switch using at least one other pressure gauging device. And this method preferably includes the step of calibrating at least one flow recharge rate through at least one flow restriction device using at least one other flow meter.

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

1) A unified secondary containment system, relating to environmentally-hazardous petroleum products, comprising, in combination: a) tank means for containing such environmentally-hazardous petroleum products; b) piping means for transporting such environmentally-hazardous petroleum products; c) tank envelope means for essentially enveloping said tank means; d) tank interstitial space means, interstitial between said tank means and said tank envelope means, for secondary containment of such environmentally-hazardous petroleum products; e) piping envelope means for essentially enveloping said piping means; and f) piping interstitial space means, interstitial between said piping means and said piping envelope means, for secondary containment of such environmentally-hazardous petroleum products; g) wherein said tank interstitial space means and said piping interstitial space means in fluid communication together comprise combined interstitial space means for secondary containment of such environmentally-hazardous petroleum products; and h) gas-pressure setting means for setting at least one combined level of gas pressure in said combined interstitial space means substantially less than at least one tank level of gas pressure in said tank means and substantially less than at least one piping level of gas pressure in said piping means.

2) The unified secondary containment system according to claim 1 further comprising monitoring means for essentially-continuous monitoring of said combined interstitial space means to detect deviations from such set at least one combined level of gas pressure.

3) A unified secondary containment system, relating to environmentally-hazardous petroleum products, comprising, in combination: a) at least one tank adapted to contain such environmentally-hazardous petroleum products; b) at least one piping adapted to transport such environmentally-hazardous petroleum products; c) at least one tank envelope structured and arranged to essentially envelope said at least one tank; d) at least one tank interstitial space, interstitial between said at least one tank and said at least one tank envelope, adapted to secondary containment of such environmentally-hazardous petroleum products; e) at least one piping envelope structured and arranged to essentially envelope said at least one piping; f) at least one piping interstitial space, interstitial between said at least one piping and said at least one piping envelope, adapted to secondary containment of such environmentally-hazardous petroleum products; g) wherein said at least one tank interstitial space and said at least one piping interstitial space in fluid communication together comprise at least one combined interstitial space adapted to secondary containment of such environmentally-hazardous petroleum products; and h) at least one gas-pressure setter structured and arranged to set at least one combined level of gas pressure in said at least one combined interstitial space substantially less than at least one tank level of gas pressure in said at least one tank and substantially less than at least one piping level of gas pressure in said at least one piping.

4) The unified secondary containment system according to claim 3 further comprising at least one monitor structured and arranged to essentially-continuously monitor said combined interstitial space to detect deviations from the at least one combined level of gas pressure.

5) The unified secondary containment system according to claim 4 wherein said at least one monitor comprises at least one computer monitor structured and arranged to computer-assistedly monitor gas pressure in said at least one combined interstitial space.

6) The unified secondary containment system according to claim 5 further comprising at least one pump adapted to assist delivery of such environmentally-hazardous petroleum products.

7) The unified secondary containment system according to claim 6 wherein said at least one monitor comprises at least one alarm signal adapted to turn off said at least one pump.

8) The unified secondary containment system according to claim 3 wherein said at least one gas pressure setter comprises at least one fluid flow system adapted to provide, essentially by Bernoulli effect, such at least one combined level of gas pressure.

9) The unified secondary containment system according to claim 8 wherein said at least one fluid flow system comprises said at least one pump.

10) The unified secondary containment system according to claim 4 wherein said at least one monitor comprises: a) at least one first-components system structured and arranged to have at least one sensory coupling with said combined interstitial space and comprising said at least one gas pressure setter; and b) at least one second-components system structured and arranged to have at least one signal coupling and at least one control coupling with said at least one first-components system; c) wherein said at least one first-components system comprises a set of sump-access-locatable elements; and d) wherein said at least one second-components system comprises a set of operator-access-locatable elements.

11) A secondary containment system, relating to environmentally-hazardous petroleum products, comprising, in combination: a) tank means for containing such environmentally-hazardous petroleum products; b) tank envelope means for essentially enveloping said tank means; c) tank interstitial space means, interstitial between said tank means and said tank envelope means, for secondary containment of such environmentally-hazardous petroleum products; and d) gas-pressure setting means for setting at least one interstitial level of gas pressure in said tank interstitial space means substantially less than at least one tank level of gas pressure in said tank means; e) wherein said gas pressure setting means comprises fluid flow means for providing, essentially by Bernoulli effect, such at least one interstitial level of gas pressure.

12) The secondary containment system according to claim 11 wherein said fluid flow means comprises said pump means.

13) The secondary containment system according to claim 11 further comprising monitoring means for essentially-continuous monitoring of said tank interstitial space means to detect deviations from the at least one interstitial level of gas pressure.

14) A secondary containment system, relating to environmentally-hazardous petroleum products, comprising, in combination: a) at least one tank adapted to contain such environmentally-hazardous petroleum products; b) at least one tank envelope structured and arranged to essentially envelope said at least one tank; c) at least one tank interstitial space, interstitial between said at least one tank and said at least one tank envelope, adapted to secondary containment of such environmentally-hazardous petroleum products; and d) at least one gas-pressure setter structured and arranged to set at least one interstitial level of gas pressure in said at least one tank interstitial space substantially less than at least one tank level of gas pressure in said at least one tank; e) wherein said at least one gas pressure setter comprises at least one fluid flow system adapted to provide, essentially by Bernoulli effect, such at least one interstitial level of gas pressure.

15) The secondary containment system according to claim 14 wherein said at least one fluid flow system comprises said at least one pump.

16) The secondary containment system according to claim 14 further comprising at least one monitor structured and arranged to essentially-continuously monitor said tank interstitial space to detect deviations from the at least one interstitial level of gas pressure.

17) The secondary containment system according to claim 16 wherein said at least one monitor comprises at least one computer monitor structured and arranged to computer-assistedly monitor gas pressure in said at least one tank interstitial space.

18) The secondary containment system according to claim 17 further comprising at least one pump adapted to assist delivery of such environmentally-hazardous petroleum products.

19) The unified secondary containment system according to claim 18 wherein said at least one monitor comprises at least one alarm signal adapted to turn off said at least one pump.

20) The secondary containment system according to claim 16 wherein said at least one monitor comprises: a) at least one first-components system i) structured and arranged to have at least one sensory coupling with said combined interstitial space and ii) comprising said at least one gas pressure setter; and b) at least one second-components system structured and arranged to have at least one signal coupling with said at least one first-components system; c) wherein said at least one first-components system comprises a set of sump-access-locatable elements; and d) wherein said at least one second-components system comprises a set of operator-access-locatable elements.

21-45. (canceled)

46) A secondary containment system relating to environmentally-hazardous petroleum products, comprising, in combination: a) handling container means for containment during handling of such environmentally-hazardous petroleum products; b) handling container envelope means for essentially enveloping said handling container means; c) handling container interstitial space means, interstitial between said handling container means and said handling container envelope means, for secondary containment of such environmentally-hazardous petroleum products; d) gas-pressure setting means for setting at least one interstitial level of gas pressure in said handling container interstitial space means substantially less than at least one handling containment level of gas pressure in said handling container means; and e) monitoring means for essentially-continuous monitoring of said handling container interstitial space means to detect deviations from the at least one interstitial level of gas pressure.

47) The secondary containment system according to claim 46 wherein said gas pressure setting means comprises fluid flow means for providing, essentially by Bernoulli effect, such at least one interstitial level of gas pressure.

48) A secondary containment system relating to environmentally-hazardous petroleum products, comprising, in combination: a) at least one handling container adapted to contain while handling such environmentally-hazardous petroleum products; b) at least one handling container envelope structured and arranged to essentially envelope said at least one handling container; c) at least one handling container interstitial space, interstitial between said at least one handling container and said at least one handling container envelope, adapted to secondary containment of such environmentally-hazardous petroleum products; d) at least one gas-pressure setter structured and arranged to set at least one interstitial level of gas pressure in said at least one handling container interstitial space substantially less than at least one handling container level of gas pressure in said at least one handling container; and e) at least one monitor structured and arranged to essentially-continuously monitor said handling container interstitial space to detect deviations from the at least one interstitial level of gas pressure.

49) The secondary containment system according to claim 48 wherein said at least one gas pressure setter comprises at least one fluid flow system adapted to provide, essentially by Bernoulli effect, such at least one interstitial level of gas pressure.

50) The secondary containment system according to claim 49 further comprising: a) at least one interstitial riser means, including at least one sealed upper cap, adapted to provide access through said at least one handling container to said at least one handling container interstitial space; and b) at least one gas pressure line adapted to provide at least one such level of interstitial gas pressure; c) wherein said at least one sealed upper cap is adapted to provide access for said at least one gas pressure line to said at least one handling container interstitial space.

51) The secondary containment system according to claim 48 wherein said at least one monitor comprises at least one computer monitor structured and arranged to computer-assistedly monitor gas pressure in said at least one handling container interstitial space.

52) The secondary containment system according to claim 48 further comprising at least one pump adapted to assist delivery of such environmentally-hazardous petroleum products.

53) The secondary containment system according to claim 52 wherein said at least one monitor comprises at least one alarm signal adapted to turn off said at least one pump.

54) The secondary containment system according to claim 52 wherein said at least one fluid flow system comprises said at least one pump.

55) The secondary containment system according to claim 54 wherein a) said at least one pump comprises at least one vacuum port; and b) said at least one vacuum port comprises at least one source of gas pressure used by said at least one monitor.

56) The secondary containment system according to claim 48 wherein said at least one monitor comprises: a) at least one control-components system adapted to provide at least two kinds of control-components to assist monitoring of the at least one interstitial space; b) wherein at least one kind of such at least two kinds of control-components comprises at least one gas-pressure-control component adapted to assist control of gas pressure in the at least one interstitial space; c) at least one control-components box adapted to mount and enclose said at least one control-components system; d) at least one geometrical positioner adapted to locate said at least one control-components box adjacent and external to the at least one primary container; e) at least one electrical-components system adapted to provide at least one electrical component remotely coupleable with at least one such control-component; and f) at least one electrical-components box adapted to mount and enclose said at least one electrical-components system.

57) The secondary containment system according to claim 56 wherein said at least one electrical-components box comprises at least one tamper-proof system to limit unauthorized access to said at least one electrical-components system.

58) The secondary containment system according to claim 56 wherein said at least one electrical-components box comprises: a) at least one lock adapted to limit unauthorized access to the at least one electrical-components system; b) wherein said at least one electrical-components box may be safely placed in at least one easily accessible location while limiting unauthorized access to the at least one electrical-components system.

59) The secondary containment system according to claim 56 further comprising at least one electrical coupling adapted to electrically couple said at least one control-components system with said at least one electrical-components system.

60) The secondary containment system according to claim 56 further comprising at least one modem, located in said at least one electrical-components box, for assisting remote management of the secondary containment.

61) The secondary containment system according to claim 56 wherein said at least one electrical-components box comprises at least one external-surface element adapted to permit, without providing internal access to said at least one electrical-components system, at least one safety signal to be read and at least one alarm to be disabled.

62) The secondary containment system according to claim 56 wherein said at least one electrical-coupling system comprises at least one junction-box adapted to provide junction box assistance with such electrical coupling.

63) The secondary containment system according to claim 56 wherein said at least one electrical-coupling system comprises at least one wireless communicator adapted to wirelessly assist such electrical coupling.

64) The secondary containment system according to claim 56 wherein said at least one gas-pressure-control component comprises at least one differential pressure switch adapted to signal operation within at least one preferred range of interstitial-space gas pressure.

65) The secondary containment system according to claim 56 wherein said at least one gas-pressure-control component comprises at least one valve adapted to control gas pressure entry to such at least one interstitial space.

66) The secondary containment system according to claim 56 wherein said at least one differential pressure switch is electrically coupled with at least one such electrical component.

67) The secondary containment system according to claim 65 wherein at least one such electrical component of said at least one electrical-components box is adapted to control said at least one valve.

68) The secondary containment system according to claim 67 wherein said at least one gas-pressure-control component comprises at least one tank-safety pressure limiter connected between said at least one valve and such at least one interstitial space.

69) The secondary containment system according to claim 67 wherein said at least one gas-pressure-control component comprises at least one gas pressure flow rate restrictor adapted to restrict the rate of gas pressure flow between at least one source of unregulated gas pressure and such at least one interstitial space.

70) The secondary containment system according to claim 56 wherein: a) said at least one control-components system comprises at least one control component adapted to send at least one signal in the presence of liquid; b) wherein such at least one signal is adapted to be sent to at least one such electrical component of said at least one electrical-components box; and c) said at least one electrical-components box is adapted to generate at least one alarm upon receiving such at least one signal.

71) The secondary containment system according to claim 70 wherein said at least one control component adapted to send at least one signal in the presence of liquid comprises at least one liquid holding vessel comprising at least one float switch.

72) The secondary containment system according to claim 56 wherein said at least one electrical-components system comprises at least one microprocessor structured and arranged to: a) be user-programmable to set alarm conditions and to set control operations of such at least one control-components system; b) receive signal information from at least such at least one control-components system; and c) send control signal adapted to control i) at least one pump adapted to pump such environmentally-hazardous products, ii) at least one gas-pressure valve, and iii) at least one alarm condition.

73) The secondary containment system according to claim 72 wherein said at least one electrical-components system comprises at least one power supply adapted to provide a voltage useable by said at least one microprocessor.

74) The secondary containment system according to claim 72 wherein said at least one electrical-components system comprises at least one set of relays adapted to assist control of such at least one pump and such at least one valve.

75) The secondary containment system according to claim 56 wherein said at least one control-components box contains at least one heater to adjustably heat said at least one control-components system.

76) The secondary containment system according to claim 72 wherein said at least one electrical-components box contains at least one data port adapted to provide microprocessor connectibility for diagnostic purposes.

77) The secondary containment system according to claim 64 wherein said at least one control-components box further contains at least one atmospheric gas pressure line connectible between said at least one differential pressure switch and atmospheric gas pressure.

78)-91) (canceled)

92. Apparatus for detecting fuel leaks from a fuel delivery system comprising a fuel conduit connected to an underground storage tank for transferring fuel therefrom and a conduit surrounding containment envelope defining with said conduit a pipe interstitial space therebetween, and including:
a submersible turbine pump having a pump element within an underground storage tank and a vacuum producing element operably connected to said pipe interstitial space for drawing a vacuum in said space.
